(19) United States
(12) Patent Application Publication
(10) Pub. No.: US 2007/0077071 A1
(43) Pub. Date: Apr. 5, 2007

(54) System for measuring atmospheric turbulence

(76) Inventor: Mikhail Belenkiy, San Diego, CA (US)

Correspondence Address: TREX ENTERPRISES CORP., 10455 PACIFIC COURT, SAN DIEGO, CA, 92121, US

(21) Appl. No.: 11/542,715

(22) Filed: Oct. 2, 2006

Related U.S. Application Data
(60) Provisional application No. 60/722,749, filed on Sep. 30, 2005.

(51) Int. Cl. H04B 10/00

(52) U.S. Cl. 398/130

(57) ABSTRACT

Equipment and techniques for the accurate estimates of the turbulence profile to improve the performance of adaptive optics systems designed to compensate the degradation effects of turbulence on directed energy systems, in astronomy, and in laser communication systems. The present invention is an optical turbulence profiler. The invention includes a cross-path LIDAR. The cross-path LIDAR technique uses laser guide star technology combined with a cross-path wavefront sensing method. In this method, two Rayleigh, or sodium, laser beacons separated at some angular distance are created by using a pulsed laser and a range-gated receiver. In preferred embodiments a Hartmann wavefront sensor measures the wavefront slopes from two laser guide stars. The cross-correlation coefficients of the wavefront slope are calculated, and the turbulence profile of refractive index structure characteristic Cₙ²(z) is reconstructed from the measured slope cross-correlations.

This application claims the benefit of Provisional Application Ser. No. 60/722,749.

The present invention relates to systems for measuring atmospheric turbulence. This invention was made in the course of the performance of Contract No. FA9450-05-M-0064 with United States Air Force Research Laboratory and the United States Government has rights in the invention.

### BACKGROUND OF THE INVENTION

Random variations of the index of refraction called refractive degrade laser beams that propagate through the atmosphere including high-energy laser (HEL) beams. High bandwidth tracking and adaptive optics (AO) systems can compensate for the effects of turbulence. However, in order to understand the results of the laser propagation tests with AO systems, knowledge of the distribution of the strength of turbulence along the propagation path is required. A required optical sensor must have high spatial and temporal resolution, be independent of availability of stars, be able to operate in the presence of strong turbulence, and sense turbulence from ground-to space, between two points on the ground, and from an aircraft.

The known methods for turbulence profile determination, including temperature probes, differential image motion (DIM) sensor, scintillation detection and ranging (SCIDAR) sensor, differential image motion (DIM) LIDAR, and slope detection and ranging (SLODAR) sensor have various limitations. In particular:
in-situ measurements using temperature probes are not possible in many situations
DIM sensor provides only path-integrated information. It is limited to weak scintillation regimes. It measures Fried parameter, r₀, not the turbulence profile
the SCIDAR is based on scintillation measurements. It requires and is limited by availability of bright binary stars.
a DIM LIDAR probes the atmosphere sequentially at different locations along the path. Consequently, it has limited temporal resolution.
a SLODAR depends on availability of binary stars. It does not allow us to measure turbulence from a moving platform.

What is needed is a better system for measuring turbulence profiles.

### SUMMARY OF THE INVENTION

The present invention provides equipment and techniques for the accurate estimates of the turbulence profile to improve the performance of adaptive optics systems designed to compensate the degradation effects of turbulence on directed energy systems, in astronomy, and in laser communication systems. The present invention is an optical turbulence profiler. The invention includes a cross-path LIDAR. The cross-path LIDAR technique uses laser guide star technology combined with a cross-path wavefront sensing method. In this method, two Rayleigh, or sodium, laser beacons separated at some angular distance are created by using a pulsed laser and a range-gated receiver. In preferred embodiments a Hartmann wavefront sensor measures the wavefront slopes from two laser guide stars. The cross-correlation coefficients of the wavefront slope are calculated, and the turbulence profile of refractive index structure characteristic Cₙ²(z) is reconstructed from the measured slope cross-correlations.

Applicants have validated the feasibility of the cross-path LIDAR technique and performed the following tasks:

a) carried out a performance analysis for the field demonstration at North Oscura Peak (NOP) and Starfire Optical Range (SOR),

b) determined an optimal spectral waveband and best imaging camera for the field demonstration at North Oscura Peak (NOP)

c) developed an analytical model for the cross-path LIDAR and validated this model using wave optics code,

d) performed the sensitivity analysis of the wavefront slope cross-correlation to the variations of the turbulence profile,

e) developed an inversion algorithm for reconstruction of the turbulence profile and tested this using simulated data that include measurement noise,

f) determined requirements for the cross-path LIDAR design, and

g) evaluated the possibility of sensing turbulence outer scale and wind velocity using cross-path LIDAR.

In the course of these efforts:
An analytical model for the cross-path LIDAR was developed and validated using wave-optics simulation code. Applicants found that the analytical model is accurate and agrees well with predictions from the wave-optics code.
The sensitivity of the cross-correlation coefficients of the wavefront slopes to variations of the turbulence profile was evaluated. Applicants found that the cross-correlation coefficient of a wavefront slope is highly sensitive to variations of the turbulence profile.
The inversion algorithm for reconstruction of the turbulence profile was developed and tested in simulation. Applicants found that the algorithm is accurate and robust to measurement noise.
The requirements for the cross-path LIDAR hardware design and data collection procedure were determined. Applicants found that the rms jitter of the image of a Rayleigh beacon exceeds the rms jitter of the transmitted beam by a factor of 2.6. This fact should be taken into account in determining requirements for the dynamic range of a wavefront sensor for a cross-path LIDAR. Also Applicants determined that a pulsed laser from Spectra Physics with 30 Hz pulse repetition rate that is available at NOP is adequate to achieve good statistical accuracy for the wavefront slope statistical moments for the field demonstration of a cross-path LIDAR.
The effects of turbulence and diffraction on the Rayleigh beacons images with variable separation between the LGSs were evaluated using a wave-optics code. Applicants found that when the angular separation between the Rayleigh beacons is 40 urad, the LGS images do not overlap.
A perspective elongation effect of a Rayleigh beacon for the field demonstration at NOP was evaluated. Applicants found that this effect is small.
Performance analysis of two measurement schemes for field demonstration of the cross-path LIDAR technique at the SOR and NOP was performed. Applicants found that the proposed field demonstration at NOP and SOR is feasible. Applicants identified the optimal spectral waveband and optimal imaging camera for the NOP demonstration. Applicants found that a doubled frequency laser from Spectra Physics operating at 532 nm wavelength in conjunction with the CCD camera from Roper Scientific provide the best performance.
Applicants showed the cross-path LIDAR is able to measure three atmospheric characteristics: turbulence profile, turbulence outer scale, and wind velocity from which two wave propagation parameters including Fried parameter and Greenwood frequency can be calculated.

### BRIEF DESCRIPTION OF THE DRAWINGS

FIG. 1 shows a cross path LIDAR technique.

FIG. 2 shows signal to noise information at a demonstration.

FIG. 3 shows measured number of photons.

FIG. 4 shows a calculated number of photons.

FIG. 5 shows path weighting functions for natural guide stars.

FIG. 6 shows path weighting functions for sodium LGS.

FIG. 7 shows path weighting functions for Rayleigh LGS.

FIG. 8 shows models of turbulence profile information.

FIGS. 9, 10 and 11 show cross-correlation coefficients.

FIG. 12A-12D are comparisons of cross-correlations.

FIG. 13 is a guide star schematic.

FIG. 14 is an intensity pattern at 15 km with 1064 nm beams.

FIG. 15 is an intensity pattern at 15 km with 532 nm beams.

FIGS. 16-21 show turbulence profiles.

FIGS. 22A-22C and 23A-23D show comparisons of cross-correlation coefficients

FIGS. 24A and 24B show turbulence profiles.

FIG. 25 shows jitter.

FIG. 26 show jitter comparison.

FIGS. 27-30 show wave front slope variance.

FIG. 31 shows a transmitter transmitting two culminated beams.

FIG. 32 shows a beam train with a beam splitter and a fold mirror.

FIG. 33 shows a beam split and fed into two sensor paths.

FIG. 34 shows the rotation of a beam.

FIG. 35 shows the matching of beams with lenslet arrays in a wave front camera.

FIG. 36 shows longitudinal covariance.

FIG. 37 shows a geometrical layout.

FIGS. 38A and 38B show longitudinal and lateral normalized covariance.

FIG. 39 shows correlation coefficients.

### DETAILED DESCRIPTION OF PREFERRED EMBODIMENTS

### Cross-Path LIDAR Concept

The cross-path LIDAR uses two laser guide stars (LGSs) separated at angular distance θ that are created at the fixed measurement range using a pulsed laser. The wavefront slopes of a laser return from each LGS are measured with a Hartmann wavefront sensor having n_{sub}=D/D_{sub} sub-apertures, where D is the telescope aperture diameter, D_{sub} is the sub-aperture diameter.

The physical principal of the cross-path LIDAR is the following. For a binary LGS with angular separation θ a single turbulent layer at altitude H produces two “copies” of the aberrated wavefront in the pupil plane of the telescope, shifted by distance S=Hθ with respect to one another. Hence, the cross-correlation of the wavefront slopes has a peak at baseline separation S in the direction of the binary separation. Consequently, the cross-correlation of the wavefront slope at the separation S is sensitive to the strength of turbulence of the turbulent layer located at the altitude H where two optical paths are crossed
H=S/θ (1)

The thickness of the layer is determined by the sub-aperture diameter divided by the angular separation
δH=D_{sub}/θ (2)

This value defines the spatial resolution of the cross-path LIDAR method.

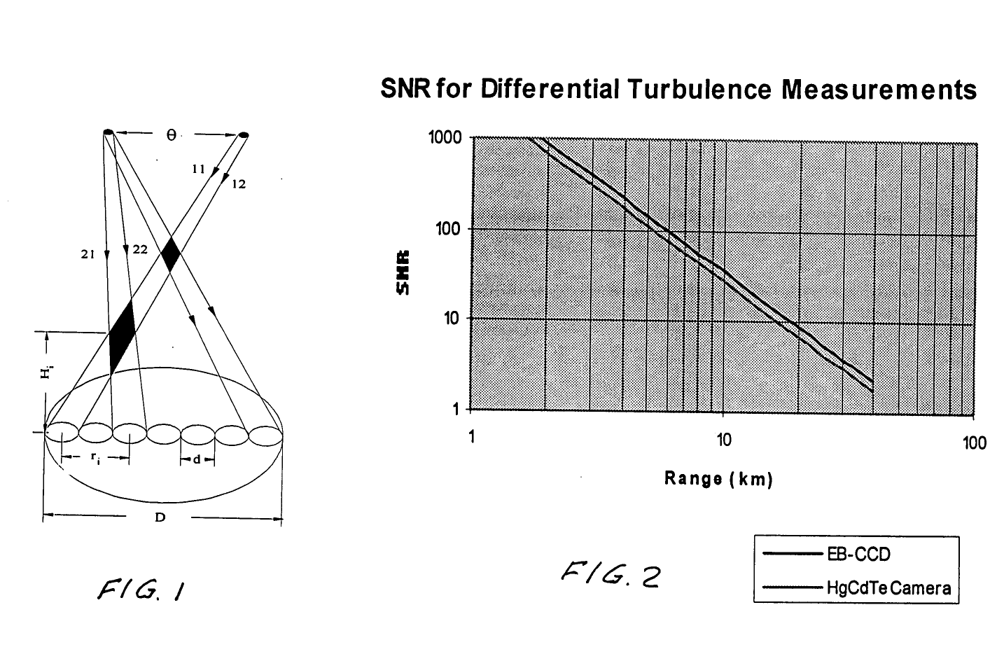

As shown in FIG. 1, each pair of sub-apertures separated at distance rᵢ, i=1, . . . , n_{sub} in the direction of the binary LGSs separation “samples” atmospheric turbulence within the layer located at the altitude Hᵢ=rᵢ/θ. For a 3.5 m diameter telescope and sub-aperture diameter of D_{sub}=0.15 m, the number of sampled turbulent layers is n_{sub}=23, whereas a 1 m diameter telescope and D_{sub}=0.1 m, this number is n_{sub}=10.

Because the wavefront slopes are measured simultaneously using n_{sub}² sub-apertures, the strength of turbulence in all n_{sub} turbulence layers at altitudes Hᵢ, i=1, . . . , n_{sub} is determined at the same time. This is one advantage of the cross-path LIDAR technique, as compared to the Differential Image Motion (DIM) LIDAR, which uses a single LGS and two spatially separated sub-apertures to perform sequential measurements of the wavefront slope statistics at altitudes Hᵢ. In order to achieve a good statistical accuracy for the wavefront slope variance, the slope measurements at each altitude Hᵢ should be averaged during 60-120 sec. To measure the strength of turbulence at 25 altitudes using this technique, one needs to collect data during 60-120 sec at each altitude. So, it will take 25-50 min to measure the turbulence profile. At the same time, using a cross-path LIDAR one can measure the entire turbulence profile during 60 sec.
The advantages of a cross-path LIDAR, as compared to the known techniques, include:
high temporal resolution because the LIDAR samples turbulence simultaneously at different locations along the path. The temporal resolution of a cross-path LIDAR exceeds that of a DIM LIDAR by more than one order of magnitude
high spatial resolution because multiple sub-apertures of a Hartmann wavefront sensor sample turbulence at different locations along the path. The number of layers is determined by the number of sub-apertures of the wavefront sensor. For binary stars, the thickness of the layers is determined by the ratio of the sub-aperture diameter to the angular distance between the laser beacons
the LIDAR is independent of the availability of natural binary stars, it can measure turbulence characteristics from ground to space, between two points on the ground, and from an aircraft
the LIDAR can operate in the regime of strong scintillation because the corresponding method is based on phase related phenomenon
the LIDAR can measure simultaneously three atmospheric characteristics: turbulence profile, Cₙ²(z), turbulence outer scale, L₀, and wind velocity, V, and
the LIDAR can operate using various optical sources: Rayleigh beacons, sodium laser guide stars (LGSs) and natural stars.

To validate the feasibility of the proposed approach, in the Phase I program we performed the following tasks: a) carried out a performance analysis and defined the corresponding hardware for the proposed field demonstration in the follow on Phase II program b) evaluated the sensitivity of the cross-correlation of a wavefront slope to the turbulence profile Cₙ²(z) variations, c) developed and tested an inversion algorithm for reconstruction of the turbulence profile, d) determined design requirements for the cross-path LIDAR; e) developed a conceptual design for the cross-path LIDAR transmitter and wavefront sensor, and finally e) developed a design for a sodium atomic line filter.

### Performance Analysis

Performance Analysis for First Field Demonstration

The uncertainty in the measurement of an image centroid position due to photon statistics is

$$ɛ = \frac{{S}_{i}}{SNR} {( 1 + \frac{{N}_{B}}{{N}_{S}} )}^{1 / 2} \qquad ( 3 )$$

where ε is the rms of image centroid, Sᵢ is the image spot diameter, N_{S} is the number of signal photons in the image, N_{B} is the number of sky background photons in the image, and SNR is the signal-to-noise ratio. Assuming 4 pixel spot size, the SNR is given by:

$$SNR = \frac{{N}_{S}}{\sqrt{{N}_{S} + 4 ( {N}_{B} + {N}_{D} + {N}_{e}^{2} )}} \qquad ( 4 )$$

where N_{D} is the number of dark current electrons per pixel and Nₑ is the number of read noise electrons per pixel.

The measurements of the photon flux from the laser-pumped sodium LGS at the SOR were recently reported. The sodium laser had 20 W average power. 8.5 W of compensated pump laser power was transmitted out the top of the telescope. The measured flux from the sodium beacon was F=800 photons/s/cm². The full width half maximum (FWHM) of the LGS spot size was 4 μrad .

If the sub-aperture diameter is D_{sub}=0.15 m and exposure time is 10 msec, than the number of signal photons is N=1800 photons/sub aperture. If the quantum efficiency of the camera is QE=80%, than the number of electrons per sub-apertures is Nₛ=1440. Finally, if the LGS image falls into four pixels, then the number of signal electrons per pixel is Nₛₚ=360. Assuming that the read noise of the CCD camera is Nₑ=6 photoelectrons/pixel, and excluding dark current and background photons, one obtains SNR=16. For a 4 μrad spot diameter and SNR=16, the rms centroid error is ε=0.26 μrad . According to the field data acquired at the SOR, as well as according to the HV 5/7 turbulence model, for D_{sub}=0.15 m, the turbulence-induced rms image centroid is 3.6 μrad . Therefore, the wavefront slope measurement error is less than 10%.

Performance Analysis for Second Field Demonstration

Next we carry out the performance analysis for the field demo at NOP. We will assume that a 1 m telescope, a pulsed laser, and range-gated cameras will be available for the field demonstration in the follow on Phase II program. The pulsed laser from Spectra Physics operates at 1.064 μm, has pulse repetition rate of 30 Hz, energy per pulse E=1 J/pulse, and diffraction limited beam quality (M²=1). A 1 m diameter telescope will be used to receive laser returns. Finally, a Hartmann wavefront sensor with sub-aperture diameter D_{S}=10 cm, will be used to measure the wavefront slopes. In addition, we assume that the backscatter coefficient is β=6×10⁻⁷ m¹sr⁻¹, two-way atmospheric transmission is 0.25, transmitter efficiency and receiver efficiency is 0.5, optical bandwidth 3 nm . The length of the scattering volume is determined by the exposure time of a range-gated camera.

We consider two range-gated cameras available at NOP including a) an electron bombarded CCD (EB-CCD) and b) a range-gated focal plane array from Rockwell. The EB-CCD is sensitive at 1.06 μm, it has 128×128 pixels, quantum efficiency, QE=30%, read noise of 6 photoelectrons/pixel, frame rate up to 20 kHz, and maximum exposure time 1 μsec. A range-gated camera from Rockwell is sensitive in the spectral waveband 0.9-2.1 μm. This camera has 128×128 pixels, QE=70%, read noise is 90 photoelectrons/pixel, frame rate up to 15 kHz, exposure time is 5 μsec. An exposure time of 1 μsec corresponds to a sampling volume of 150 m, and for an exposure time of 5 μsec, the sampling volume is equal to 750 m.

The SNR calculations for the field demonstration at NOP are shown in FIG. 2. It is seen that an electron bombarded CCD has a slight advantage over the Rockwell camera. At 15 km range the SNR=18. Since the wavelength is λ=1.06 μm and the sub-aperture diameter is D_{sub}=0.1 m, the image spot size is 10 μrad . Consequently, the rms centroid error is 0.55 μrad. For the HV5/7 turbulence model and zenith angle of 60 degrees, turbulence-induced rms centroid motion is 7.3 μrad. Thus the wavefront slope measurement error is 7.5%. Thus, in both astronomical and ABL application using the equipment available at the SOR and NOP, respectively, one can perform the slope measurements with an error less than 10%. Note that if the CCD camera with an exposure time of 33 μsec would be used in the NOP demonstration, then the corresponding SNR for 15 km range will be increased up to SNR=100. An alternative approach is to double the frequency of the pulsed laser and low noise commercially available CCDs with long integration time. During the next month we will examine which camera and which wavelength is optimal for the field demonstration at NOP.

Optimal Spectral Waveband for Demonstration Using Rayleigh Beacons

The above analysis shows that the approach that uses a pulsed laser from Spectra Physics in conjunction with an electron bombarded CCD (EB-CCD), or a range-gated CCD from Rockwell, is feasible. However, it is not optimal. It has two shortcomings. One shortcoming is that both imaging cameras (EB-CCD and Rockwell CCD) have short exposure time (1 μsec for EB CCD and 5 μsec for Rockwell CCD). This reduces the length of the sampling volume and the SNR. The second shortcoming is that the backscatter coefficient at longer wavelength reduces as λ⁻⁴. A reduced backscatter at longer wavelength limits the laser return and reduces the SNR. An alternative approach that overcomes the above shortcomings is to double the frequency of a Spectra Physics laser and use a low-noise CCD with long exposure time. This will increase the backscatter coefficient and increase the length of the laser beacon. Consequently, the SNR will be increased. Next we will evaluate the performance of this approach.

The number of laser photons from the Rayleigh LGS can be calculated using the LIDAR equation, which is given by¹³

$$N = {N}_{o} ( \frac{A}{{R}^{2}} ) k ( \frac{c τ}{2} ) β exp [ - 2 {\int }_{o}^{R} σ ( r ) ⅆ r ] , \qquad ( 5 )$$

where N is the number of photons received,
N₀ is the number of photons transmitted in each laser pulse,
A is the receiver area (m²), R is the range (m),
k is the optical efficiency (dimensionless),
c is the speed of light (3×10⁸ m/s),
τ is the sampling interval (s),
β is the backscatter coefficient (m⁻¹sr⁻¹), and
σ(r) is the atmospheric extinction coefficient (m⁻¹).

The number of photons transmitted is related to the energy per pulse E in Joules by
N₀=λE/hc, (6)
where λ is the wavelength (in meters), h is Planck's constant, 6.63×10⁻³⁴ Js, and c is the speed of light.

The Rayleigh backscatter from clear air is calculated using a formula
β=1.39[550/wavelength(nm)]⁴×10⁻⁶ m⁻¹sr⁻¹ at sea level (7)
where the atmospheric number density is 2.55×10¹⁹ molecules per cm³. The air density is usually modeled as an exponential falloff with a scale height of about 8 km. This equation allows us to estimate the values of the backscatter coefficient at any wavelength using the measurements performed at a different wavelength.

One way to perform a link budget analysis for the cross-path LIDAR is to use the measured vertical profiles of the backscatter and extinction coefficients and the LIDAR Eq. (5). The second approach is to use the data for measured number of photons from the Rayleigh beacons reported in the literature, and to re-scale this data to the spectral waveband, energy per pulse, receiver area, length of the laser beacon, and optical efficiency of interest. We will employ the second approach.

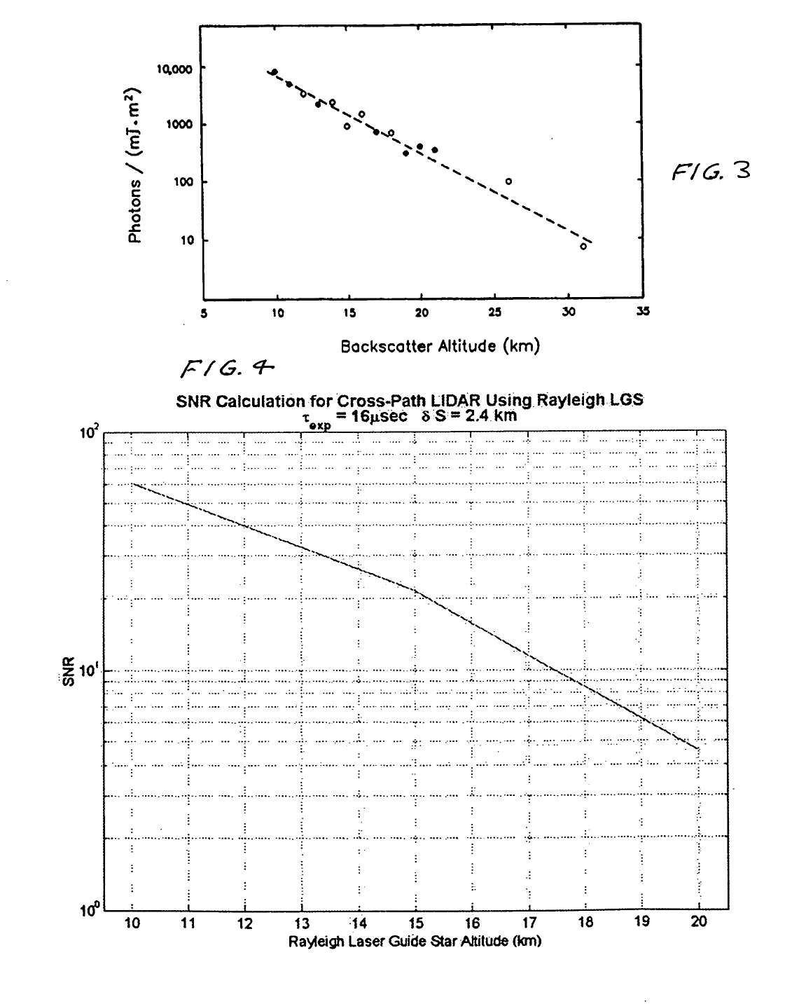

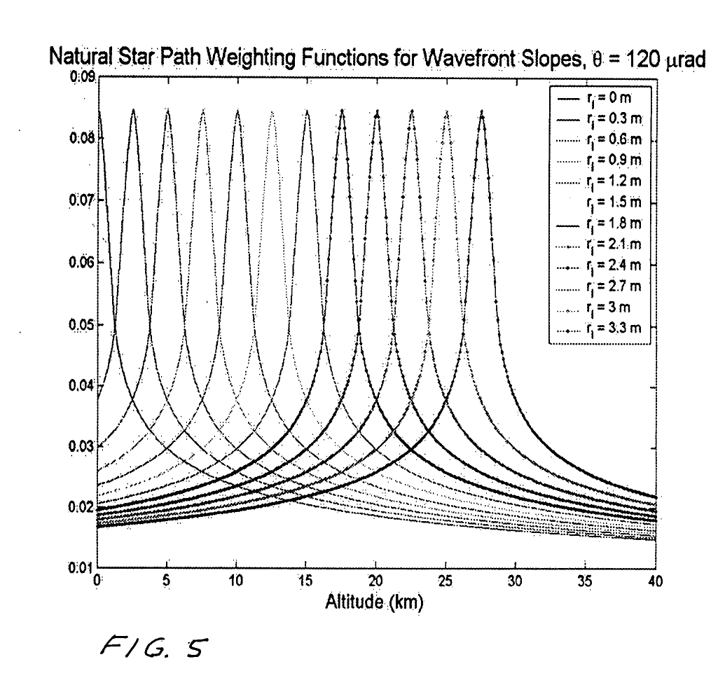

An experimental demonstration of a Rayleigh-scattered laser guide star at 351 nm in the altitude range from 10 km to 30 km was performed. FIG. 3 shows the measured number of photons versus beacon altitude. Also researchers at SOR performed the wavefront measurements using a Rayleigh beacon. In this study, a pulsed copper-vapor laser operating at 510 nm wavelength with 180 W average power was used. The pulse repetition rate is 5,000 pulses/sec, and energy per pulse is 20 mJ/pulse. Five backscatter samples at an average range of 10 km, each 16 μs long (corresponding to 2.4 km range gate) generated 190 photoelectrons detected/sub aperture. The sub aperture is 9.2 cm square. The transmitter optical efficiency is 0.3, and receiver optical efficiency is 0.25.

By using the scaling relationship given by Eq. (3) and the LIDAR equation (5), one can re-scale the above field data to the spectral waveband and LIDAR system parameters of interest. First, in order to validate this approach, we will compare the measured number of photons from a Rayleigh beacon reported in Refs. 13 and 14. From FIG. 3 one can see that the number of received photons in the UV waveband for 10 km Rayleigh beacon altitude and 2 km range gate is N=8,000 photons/mJ/m². According to Eq. (3), at 510 nm wavelength, as compared to 351 nm, the number of photons is reduced by a factor of (510 nm/351 nm)⁴=4.45. By taking into account that five samples were summed up, the transmitted energy per five samples 20 mJ/pulse×5 samples=100 mJ/sample. Also if one takes into account a sub aperture area and transmit and receive optical efficiency of the SOR system, then one obtains that the predicted number of photoelectrons is 230. This estimate is consistent with the measured number of photoelectrons (190) reported in open literature.

A Spectra Physics laser generates 1 J/ pulse. Because two LGSs are required to measure the turbulence profile, and the frequency doubling reduces the pulsed energy by about a factor of two, in the SNR calculations we assume that the laser generates 125 mJ/ pulse per laser beacon. Also according to the specification, the rms readout noise of the Photometrics camera is 6 electrons/pixel. We will use an exposure time of 13.5 μsec, or the range gate of 2 km. The SNR is defined by Eq. (4).

Now we will apply this approach to the performance analysis of the cross-path LIDAR. We will consider two options: a) frequency doubled laser Spectra Physics that operates at 532 nm wavelength in conjunction with a low-noise CCD camera (CoolSNAP_{HQ}) from Photometrics with long exposure time, and b) Spectra Physics laser operating at 1064 nm in conjunction with a range-gated EB-CCD, or Rockwell camera.

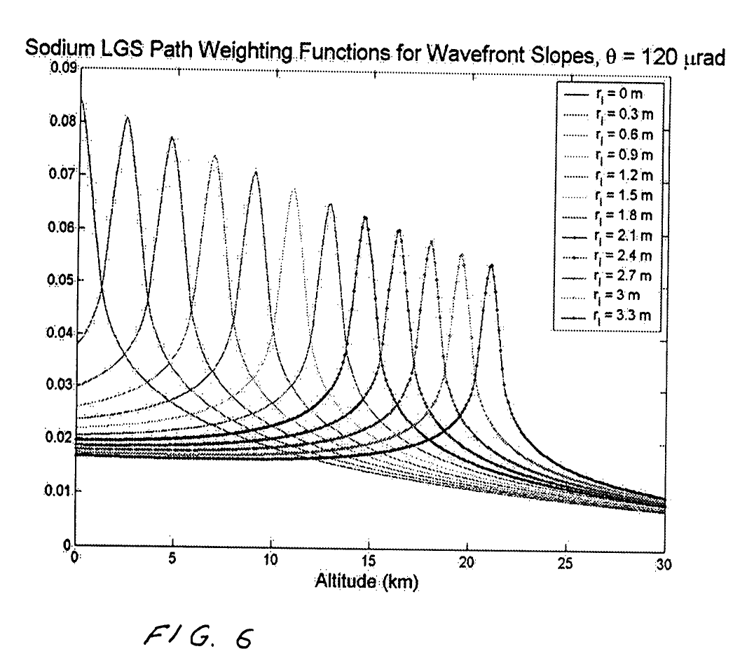

FIG. 4 depicts the calculated signal to noise ratio for the cross-path LIDAR for NOP demonstration that uses a doubled frequency laser from Spectra Physics and low-noise CCD camera from Photometrics. These calculations were performed using the data shown in FIG. 3 and scaling relationships defined by Eqs. (5)-(7). It is seen that the signal-to-noise ratio is greater than ten, when the Rayleigh beacons altitude is lower than 17.5 km. This suggests that the NOP demonstration using double frequency laser and Photometrics camera provides better performance than that using the Spectra Physics laser that operates at its fundamental frequency (1064 nm wavelength) in conjunction with EB-CCD, or Rockwell camera. We will select this approach for the field demonstration at NOP.

### Analytical Model for Cross-Path LIDAR Sensitivity Analysis

Analytical Model for the Cross-Path LIDAR Technique

We will develop an analytical model for two cases: a) when natural binary stars are used to measure the turbulence profile, and b) when Rayleigh, or sodium, laser beacons are employed. First, we will consider an astronomical scenario. We assume that two plane waves from binary stars separated at angular distance θ propagate down through the atmosphere. The optical rays of the two waves that arrive at two sub-apertures, separated at the distance rᵢ in the direction of the binary stars separation, are crossed at the altitude Hᵢ=rᵢ/θ (see. FIG. 1).

In geometrical optics approximation the phase difference between two optical rays arriving at the i^{s} sub-aperture having diameter d has the form

$${d}_{i} = ϕ ( {x}_{2 , i} ) - ϕ ( {x}_{1 , i} ) = k {\int }_{0}^{{H}_{max}} ⅆ z \{ n [ {p}_{2 , i} ( z ) ] - n [ {p}_{1 , i} ( z ) ] \} \qquad ( 8 )$$

where k is the wave number, and n[p(z)] is the refractive index along the optical ray. The cross-correlation of the wave front slopes is expressed through the combination of the phase structure functions [symbol]
d₁d₂=Dₛ( r̅ᵢ− d̅, θ̅)+Dₛ( r̅ᵢ+ d̅, θ̅)−2Dₛ( r̅ᵢ, θ̅) (9)
where the phase structure function is

$$D ( {\vec{ρ}}_{i} , θ ) = 1.45 {k}^{2} {\int }_{0}^{{H}_{max}} ⅆ {zC}_{n}^{2} ( z ) {\vert ( 1 - z / L ) {\vec{ρ}}_{i} - z \vec{θ} \vert}^{5 / 3} \qquad ( 10 )$$

Here Cₙ²(z) is the turbulence vertical profile, ρ̅= r̅ᵢ± d̅, and L is the distance of the LGS from the telescope. For natural guides stars, L=∞. We will assume that both vectors r̅ᵢ and d̅ are parallel to the vector θ̅ of the separation between the LGSs. Consequently, an integral equation that relates the cross-correlation coefficient to the turbulence profile has the form

$$b ( {r}_{i} , θ ) = {\int }_{0}^{{H}_{max}} {C}_{n}^{2} ( z ) W ( {r}_{ i} , θ , z ) ⅆ z \qquad ( 11 )$$

where b(rᵢ,θ) is the slope cross-correlation normalized to the slope variance b(rᵢ,θ)= [symbol] d₁d₂ [symbol] / [symbol] d² [symbol] , and W(rᵢθ,z) is the path weighting function. For natural guide stars the path-weighting function has the form
W(rᵢ,θ,z)=[(rᵢ−D_{sub})²−2z(rᵢ−D_{sub})θ+(zθ)²]^{5/6}+[(rᵢ+D_{sub})²−2z(rᵢ+D_{sub})θ+(zθ)²]^{5/6}−2 [rᵢ²−2zrᵢθ+(zθ)²]^{5/6} (12)

The path weighting functions for natural binary stars for astronomical application are shown in FIG. 5. The path weighting function has a peak at the altitude where two optical paths are crossed. The number of peaks of the path weighting function determines the number of sampled atmospheric layers. For D=3.5 m and D_{sub}=0.15 m, the number of “sensed” turbulent layers is n_{sub}=23.

Analytical Model for the Sodium Laser Beacons

In the case of the sodium LGSs located at 90 km altitude, the path-weighting function is given by

$$\begin{matrix}W ( {r}_{i} , θ , z ) = {[ \begin{matrix}{( 1 - \frac{z}{ {F}_{ i}} )}^{2} {( {r}_{i} - {D}_{sub} )}^{2} - \\ 2 ( 1 - \frac{z}{ {F}_{ i}} ) ( {r}_{i} - {D}_{sub} ) z θ + {( z θ )}^{2}\end{matrix} ]}^{5 / 6} + \\ {[ \begin{matrix}{( 1 - \frac{z}{ {F}_{ i}} )}^{2} {( {r}_{i} + {D}_{sub} )}^{2} - \\ 2 ( 1 - \frac{z}{ {F}_{i}} ) z ( {r}_{i} + {D}_{sub} ) θ + {( z θ )}^{2}\end{matrix} ]}^{5 / 6} - \\ {2 [ {( 1 - \frac{z}{{F}_{i}} )}^{2} {r}_{i}^{2} - 2 ( 1 - \frac{z}{{F}_{i}} ) {zr}_{i} θ + {( z θ )}^{2} ]}^{5 / 6}\end{matrix} \qquad ( 13 )$$

where Fᵢ is the focal length of the laser beam, Fᵢ=90 km. This path weighting function takes into account the spherical divergence of laser beacon waves. FIG. 6 depicts the path weighting functions for sodium LGS at 90 km.
Analytical Model for the Rayleigh LGSs

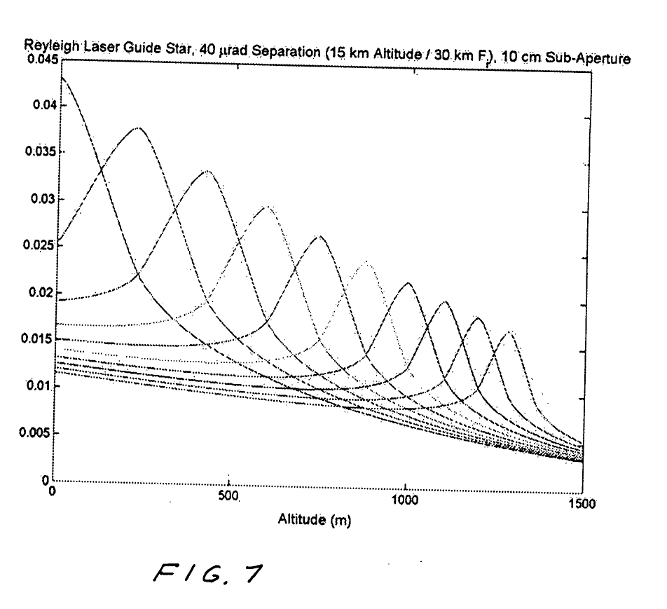

The path weighting functions for Rayleigh LGS at 15 km altitude for NOP demonstration are shown in FIG. 7. The telescope aperture diameter is 1 m, and the sub-aperture diameter is D_{sub}=0.1 m. The angular separation between the LGSs is 40 μrad, and the focal length of the laser beam is Fᵢ=30 km. The cross-correlation coefficients have 10 peaks at different altitudes, where the corresponding optical paths are crossed, Hᵢ=rᵢ/θ.

Sensitivity Analysis of the Cross Path LIDAR for Astronomical Application

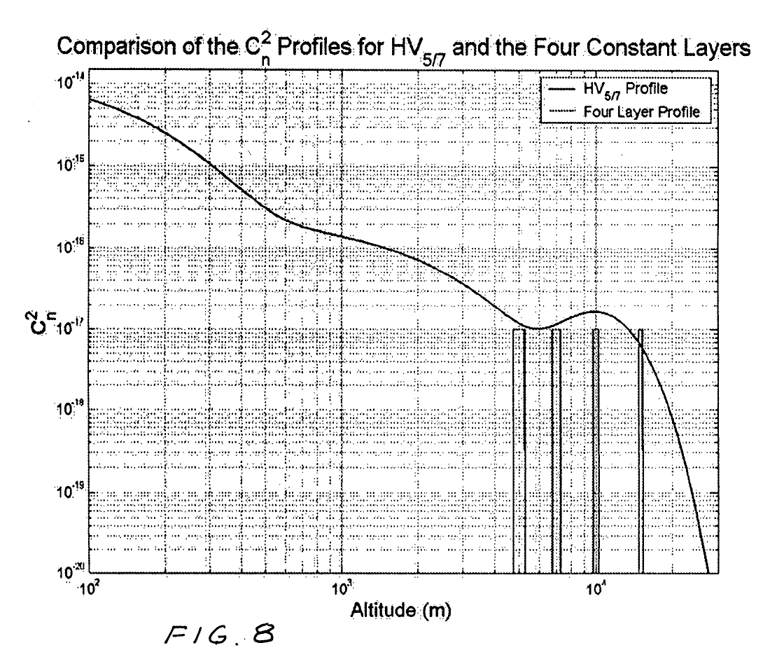

In order to evaluate the sensitivity of the slope cross-correlation to variations of the turbulence profile, we selected several models of the turbulence profile Cₙ²(z) shown in FIG. 8 and calculated the slope cross-correlation coefficients from Eq. (11). These models include: a) single turbulent layer thickness of 500 m located at 5 km altitude, b) two turbulence layers located at 5 km and 7 km, c) four turbulent layers located at 5 km, 7 km, 10 km, and 15 km altitude, d) HV_{5/7} turbulence model, and f) Cₙ²=const.

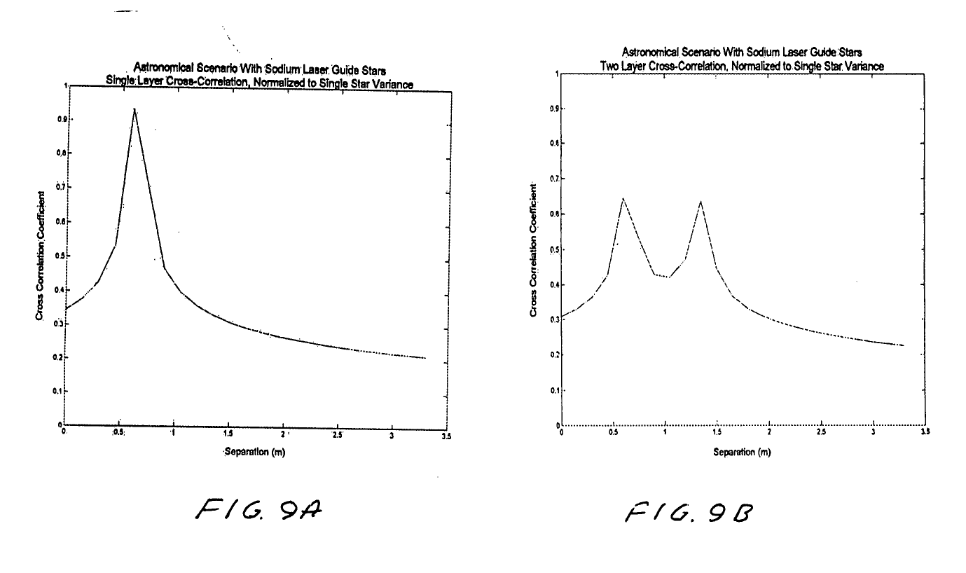

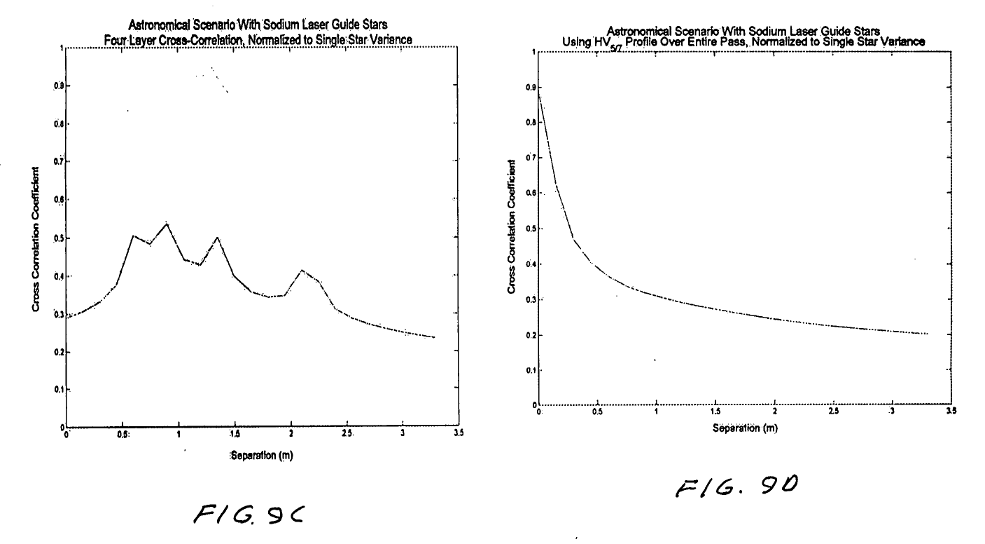

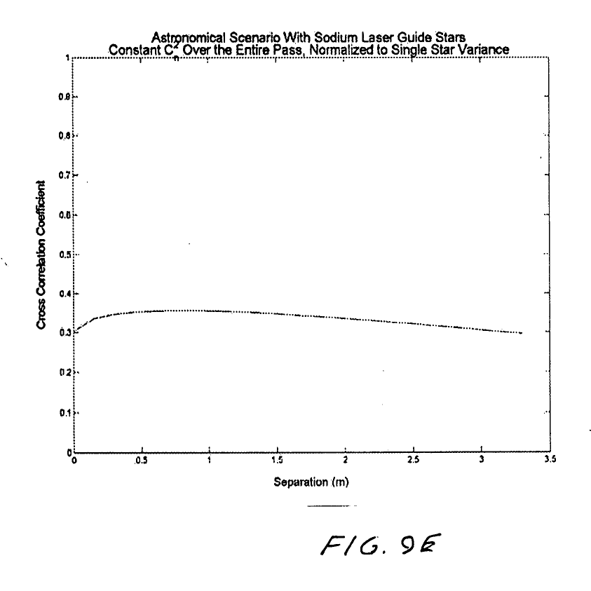

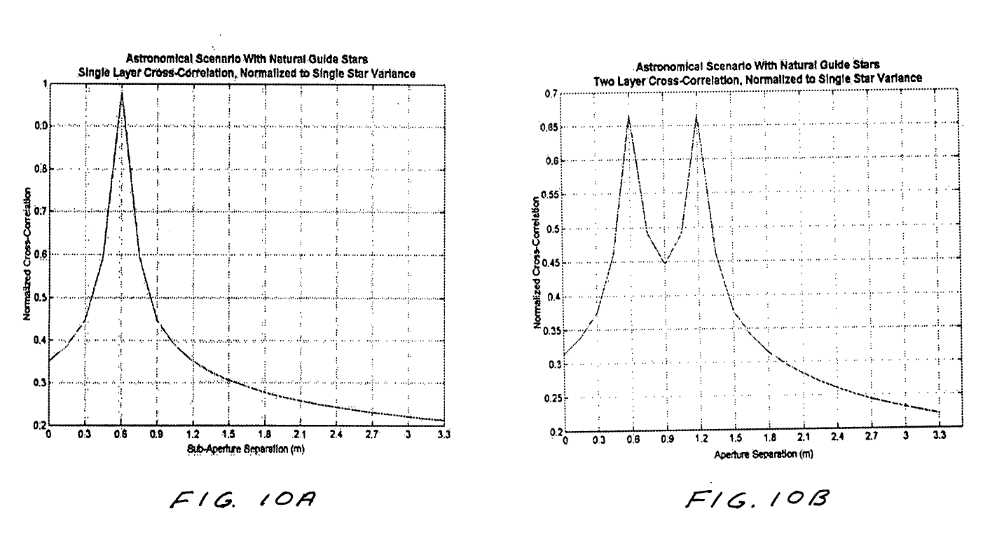

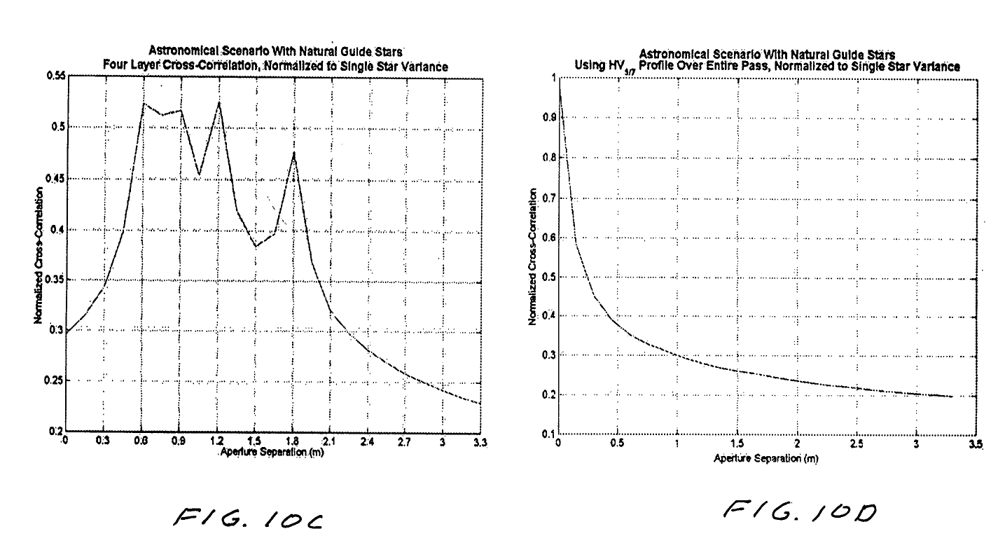

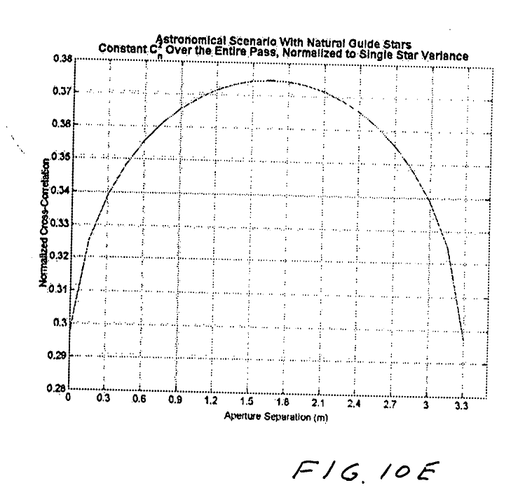

The slope cross-correlation coefficients for various turbulence profiles and natural guide stars are shown in FIG. 9. An inspection of this plot reveals that the number of peaks of the cross-correlation coefficient corresponds to the number of the turbulent layers. The peaks position versus separation between the sub-apertures corresponds to the altitude of the turbulent layer, Hᵢ=rᵢ/θ. Variations of the cross-correlation coefficients caused by variations of the turbulence profile exceed the estimated measurement accuracy of the wavefront slope of 10%. Thus, the cross-path sensing technique has good sensitivity to variations of the turbulence profile. Also, this plot suggests that the number of turbulence layers and their altitude can be directly determined from the measured slope cross-correlations.

The slope cross-correlation coefficients for Rayleigh LGSs are shown in FIG. 11. As in two previous cases, each turbulence layer produces a peak in the slope cross-correlation plotted versus separation between the sub-apertures. The peak position depends on the altitude of the turbulent layer, Hᵢ=rᵢ/θ. Thus, in case of Rayleigh beacons, a cross-path LIDAR technique also has good sensitivity to variations of the turbulence profile.

### Validation of Cross-Path LIDAR Model in Simulation

To validate the analytical model given by Eq. (11) for the cross-path LIDAR technique, we performed the following study. By using a wave-optics simulation code we simulated the propagation of two optical waves with angular separation of θ through atmospheric turbulence and also simulated the measurements of the wavefront slope using a Hartmann wave-front sensor. Then, we estimated the slope cross-correlation coefficients by averaging multiple turbulence realizations and compared the cross-correlation coefficients from the wave-optics simulation with that from the analytical model (8). We performed the simulation for the astronomical scenario using natural guide stars and a 3.5 m telescope.

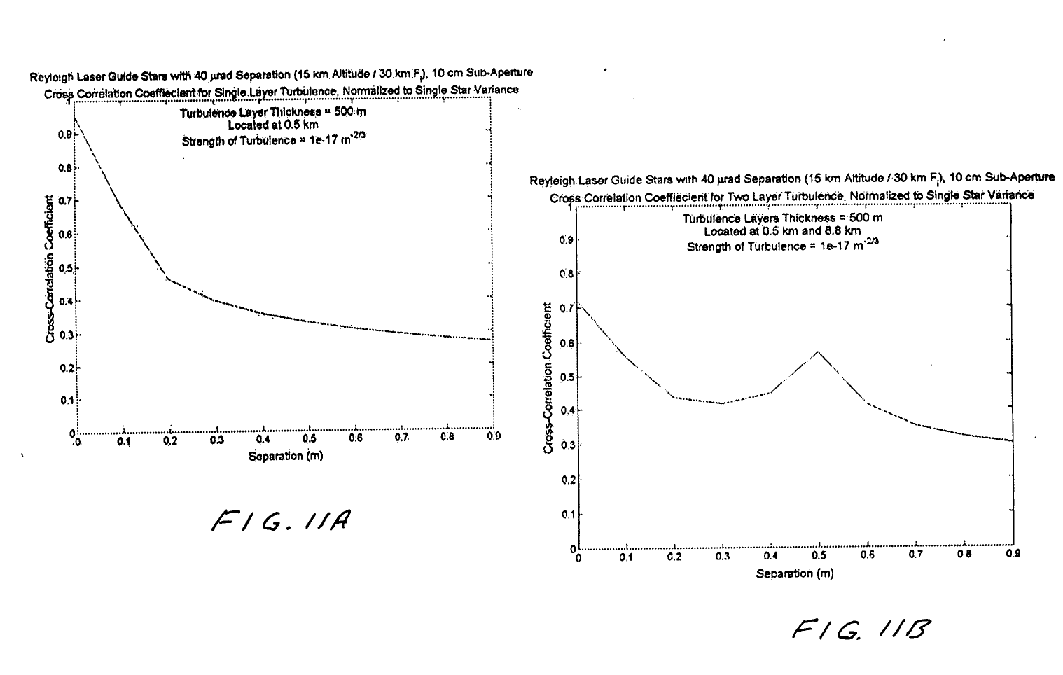

FIGS. 12A, 12C, and 12E, show the slope cross-correlation coefficients from the wave-optics simulation for three models of the turbulence profile Cₙ²(z): a) single turbulent layer at 5 km altitude c) four turbulent layers at 5 km, 8 km, 10 km, and 15 km altitude, and e) HV_{5/7} turbulent model, respectively. FIGS. 12 b, d, and f depict the corresponding slope cross-correlation coefficients for the same turbulence models calculated from Eq. (11). It is seen that in all cases the cross-correlation coefficients for longitudinal tilt from the wave-optics simulation agree well with the cross-correlation coefficients calculated from the analytical model (11). This validates the analytical model for the cross-path LIDAR technique.

Also from FIGS. 12A, 12C, and 12E one can see that the level of cross-correlation for the lateral tilt exceeds the corresponding level for the longitudinal tilt. This result is consistent with the known fact that the tilt correlation is reduced in the direction of separation of the LGSs. An agreement of the analytical model (11) with the cross-correlation coefficients for the longitudinal slope was expected because in the derivation of Eq. (11) the assumption was used that the vectors r̅ᵢ and d̅ are parallel to the vector θ̅.

### Elongation Effect and Angular Separation of Rayleigh Beacons

Perspective Elongation Effect for the Rayleigh Beacons

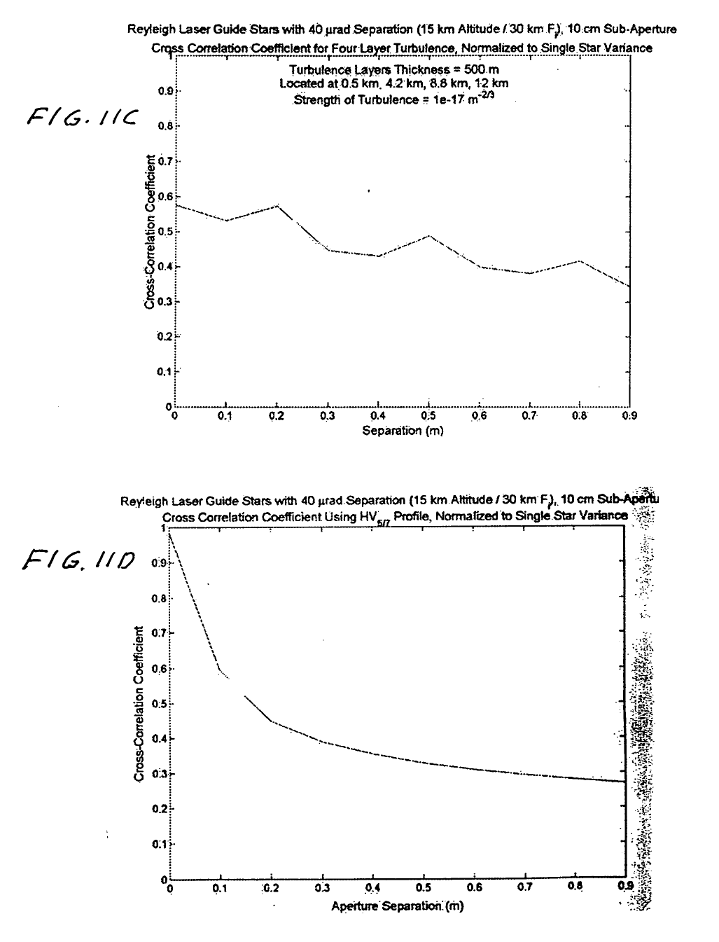

When a LGS is observed through a sub-aperture separated from the optical axis of the telescope at some distance r, the LGS image is elongated.¹⁶ This effect is illustrated in FIG. 13. Here H is the LGS altitude, h is the LGS length, r is the distance of the sub-aperture from the optical axis of the telescope, and sin φ=r/H.

It is easy to see that the LGS image elongation is related to the LGS length and altitude, and distance r from the optical axis by equation

$$δ l = \frac{h \times r}{{H}^{2}} \qquad ( 14 )$$

If the telescope diameter is D=1 m, r=D/2=0.5 m, H=15 km, and h=2 m, then the elongation is δl=4.4 μrad. When a laser beam is pointed off the zenith, the perspective elongation is reduced. Thus, the LGS elongation effect in the proposed field demonstration at NOP is small as compared to the turbulence-induced image blur, λ/r₀=0.532 μm/0.05 m=10.6 μrad.

Optimal Angular Separation Between the Laser Beacons

The maximum measurement range for the turbulence profile using Rayleigh beacons can be estimated from the equation that defines the separation between the sub-apertures of a wavefront sensor in the direction of the LGSs separation that corresponds to maximum cross-correlation between the wavefront slopes:
S=H×θ/(1−H/L_{LGS}) (15)

Here H is the altitude of the turbulent layer, L_{LGS} in the LGSs altitude, and θ is the angular separation between the laser beacons. Eq. (15) takes into account a spherical divergence of the beacon waves that reduces the maximum measurement range for the turbulence profile.

For L_{LGS}=15 km, θ=40 μrad, and telescope diameter of D=1 m, maximum separation between the sub-apertures is 0.9 m., and the maximum measurement range is 9 km. The maximum measurement range increases with increasing telescope diameter, and/or with reducing the angular separation between the LGSs. However, atmospheric turbulence and diffraction blur the LGS image and limit the minimal angular separation between the Rayleigh beacons when the beacons images do not overlap. Under this task, by using a wave-optics code, we investigated the effects of turbulence and diffraction on images of the Rayleigh beacons at various angular separations and determined the minimal separation when the beacons images do not overlap.

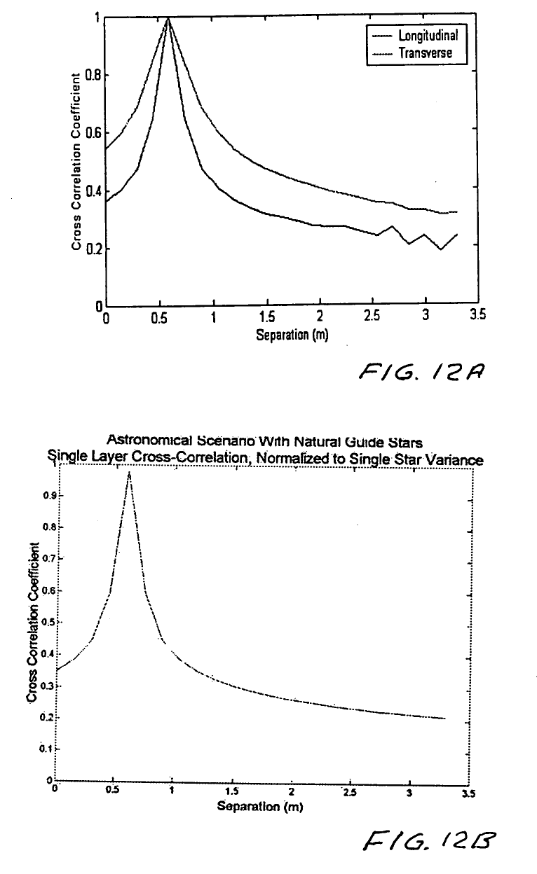

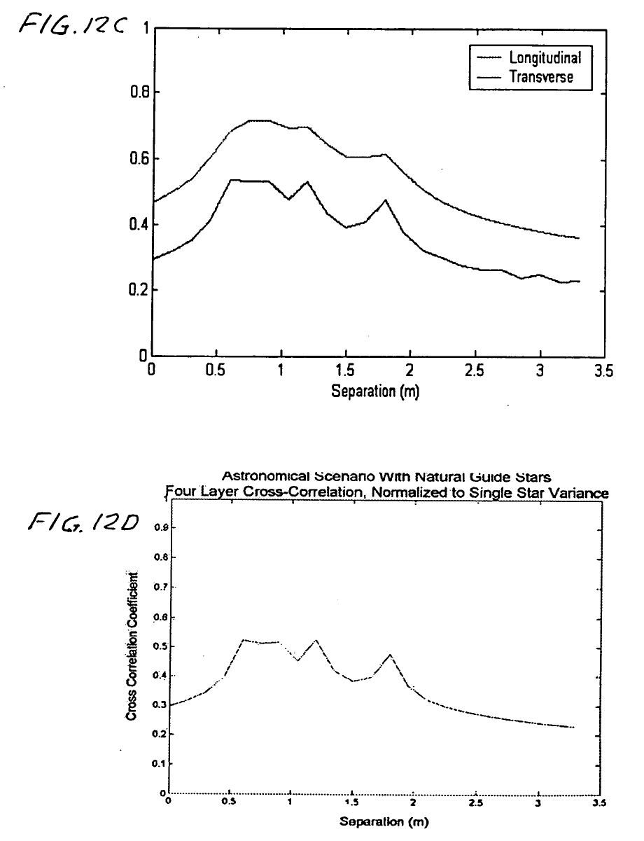

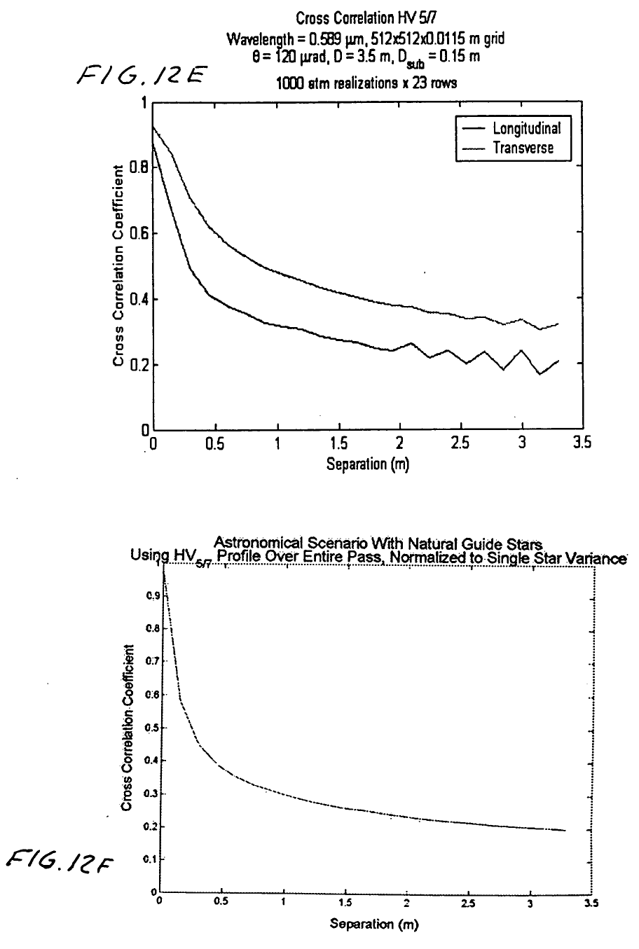

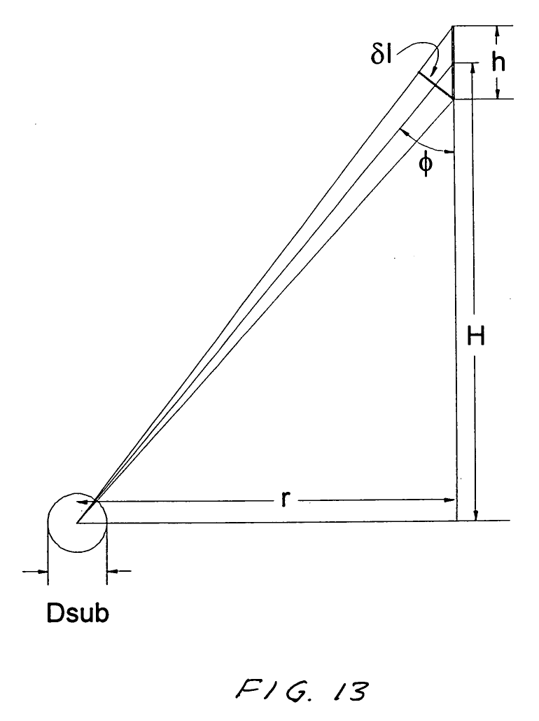

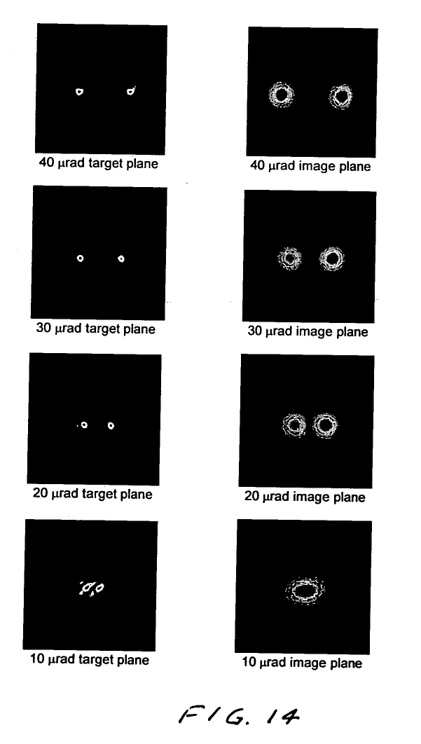

Intensity patterns in two focused beams in the target plane (left column) and intensity patterns in the image plane of the receiving telescope (right column) are shown in FIG. 14. The wavelength is 1064 nm, the LGSs altitude is 15 km, the transmitter aperture diameter is 30 cm, and the beams are focused at 15.73 km range. The LGS images are formed through a sub-aperture of 10 cm diameter. The HV_{5/7} turbulence model was used in the simulation. It is seen that when the separation between the LGSs is less than, or equal to 30 μrad, the LGSs images are overlapped. The latter is due to turbulence and diffraction. For a 40 μrad separation, the LGSs images are well separated.

FIG. 15 shows similar results for two laser beams at 532 nm wavelength. It is seen, that the atmospheric blur at shorter wavelength in FIG. 15 is stronger than that in FIG. 14. Nevertheless, similar to the previous case, when the separation is 40 μrad, the LGSs images are well separated. The images are overlapped when the separation is less than, or equal to 30 μrad . This defines the minimal angular separation between the LGSs for the demonstration at NOP.

### Inversion Algorithm

Chahine Iterative Inversion Algorithm

Eq. (11) is Fredholm-type integral equation of the first kind with kernel W(rᵢ,θ,z). In this equation, b(rᵢ,θ) is the measured function, and Cₙ²(z) is the unknown function. A range-discrete version of Eq. (11) results in a matrix equation for calculating Cₙ²(zⱼ) values at discrete ranges zⱼ. j=1, . . . , n, which has the form

$${b}_{i} = {\sum }_{j = 1}^{n} {W}_{ij} {C}_{j} + {N}_{i} \qquad ( 16 )$$

where bᵢ=B(rᵢ,θ)/B(0,0), Cⱼ=Cₙ²((j−½)Δz),

$${W}_{ij} = {\int }_{( j - 1 ) Δ z}^{j Δ z} W ( {r}_{i} , θ , z ) ⅆ z$$

and Nᵢ is the measurement noise. Due to the singular nature of the mathematical inversion procedure of the integral equation (16) of the first kind and the measurement noise, standard matrix inversion techniques are numerically unstable. Therefore, to retrieve the turbulence profile Cₙ²(zⱼ) from Eq. (16) a special-purpose inversion algorithm must be developed.

As a baseline approach for turbulence profile reconstruction we selected the Chahine iterative algorithm. The basic idea of this method is to find the unknown function whose values when they are inserted into the Eq. (16) produce minimum deviation from the measured function b(rᵢ,θ). The procedure begins from selection of an initial guess for the turbulence profile. Once an initial guess Kⱼ⁰=[Cₙ²(zⱼ)]⁽⁰⁾ is selected, we use this turbulence profile as an input to Eq. (11) to calculate

$${α}_{cal}^{0} ( {r}_{i} ) = {\sum }_{j = 1}^{{n}_{s}} {K}_{j}^{0} {W}_{ij} .$$

The method performs multiple iterations to reduce the deviation from the measured function. If we denote the turbulence profile recovered after the n^{th} iteration as Kⱼⁿ=[Cₙ²(zⱼ)]⁽ⁿ⁾, and aₘₑₐₛ(r_{i)=b(r}ᵢ,θ) are the measured cross-correlation coefficients, then, first, for the turbulence profile Kⱼⁿ the estimates of the cross-correlation coefficient are calculated

$${α}_{cal}^{n} ( {r}_{i} ) = {\sum }_{j = 1}^{{n}_{s}} {K}_{j}^{n} {W}_{ij} \qquad ( 17 )$$

and the turbulence profile is corrected as

$${K}_{j}^{n + 1} = {K}_{j}^{n} \frac{{α}_{meas} ( {r}_{j} )}{{α}_{cal}^{n} ( {r}_{j} )} . \qquad ( 18 )$$

The convergence is estimated by calculating the root mean square residual error

$$ɛ = {\{ \frac{1}{{n}_{s}} {\sum }_{i = 1}^{{n}_{s}} \frac{{[ {α}_{meas} ( {r}_{i} ) - {α}_{cal}^{n} ( {r}_{i} ) ]}^{2}}{{[ {α}_{cal}^{n} ( {r}_{i} ) ]}^{2}} \}}^{1 / 2} , \qquad ( 19 )$$

where n_{sub} is the number of sub-apertures across the telescope aperture, as well as the number of “sensed” turbulence layers.
Astronomical Applications Using Sodium LGSs

Three examples of the reconstructed turbulence profiles using Chahine inversion algorithm for astronomical applications are shown below. FIG. 16 depicts the original HV_{5/7} turbulence profile, an initial guess, and reconstructed profiles that correspond to different numbers of iterations. It is seen that the reconstructed profile approaches the “true” profile by increasing the number of iterations, and the root mean square residual error is reduced.

One can make similar observations from FIG. 17, which depicts an original profile, initial guess, and reconstructed profiles for various numbers of iterations for the step function Cₙ²(zⱼ) profile. When the number of iterations increases, the reconstructed turbulence profile approaches the original profile.

Finally, FIG. 18 shows an original profile, initial guess, and reconstructed profiles for various numbers of iterations for a two-layer Cₙ²(zⱼ) profile. It is seen that in this case, the reconstructed algorithm correctly determines the number of layers, their altitudes, and the Cₙ² values in each layer. However, the thickness of the layers is overestimated. We believe that higher spatial resolution of the cross-path LIDAR will improve the turbulence profile reconstruction.

Field Demonstration at NOP Using Rayleigh LGSs

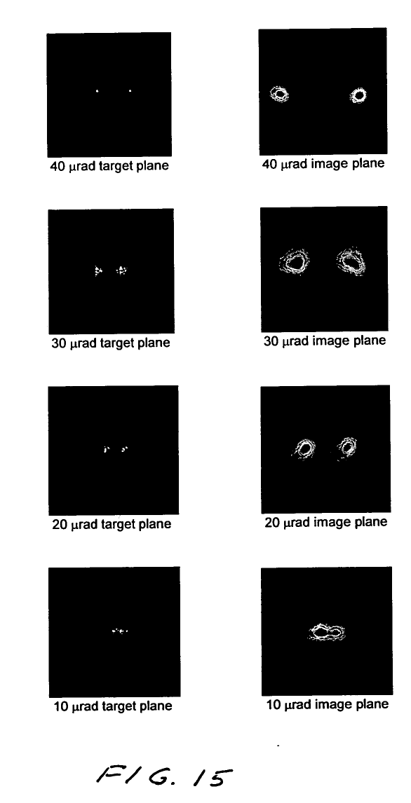

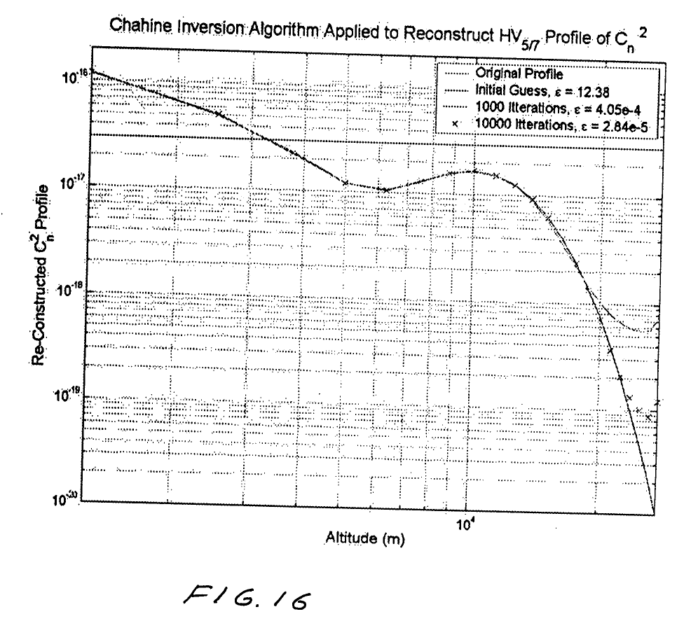

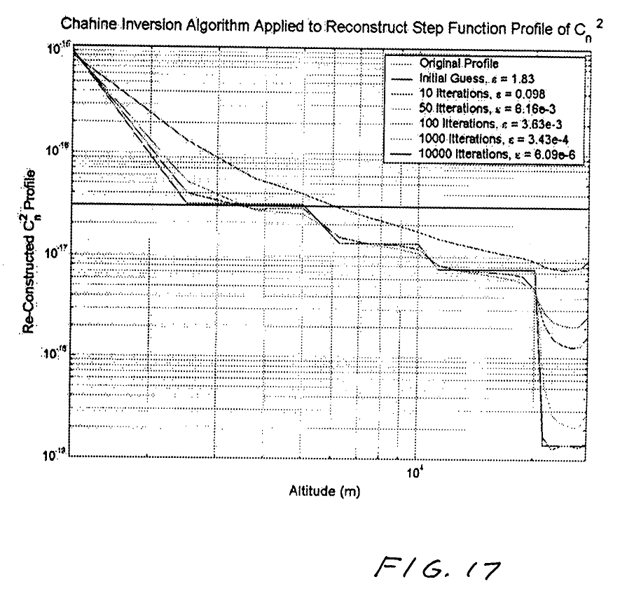

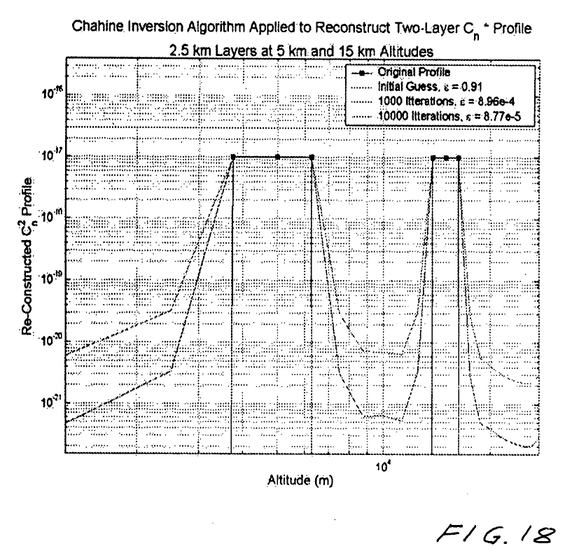

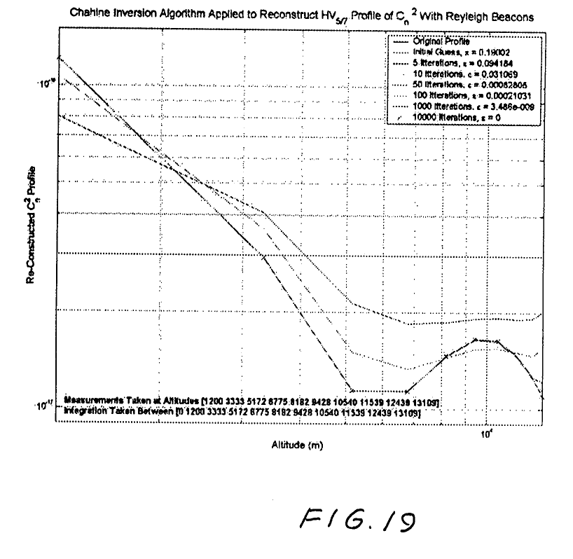

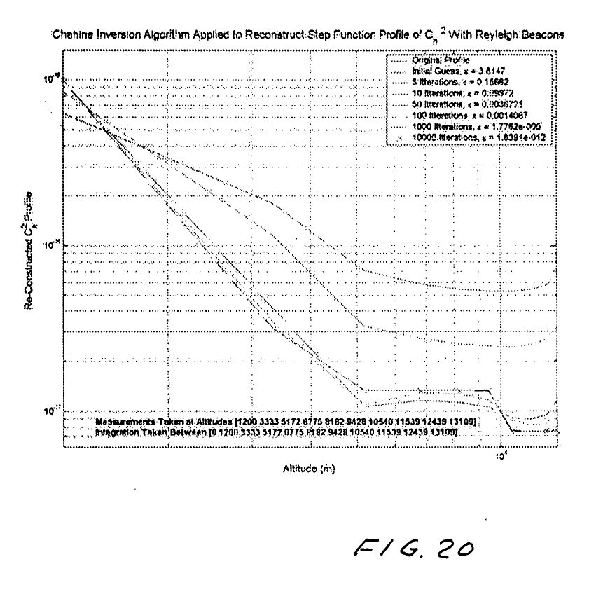

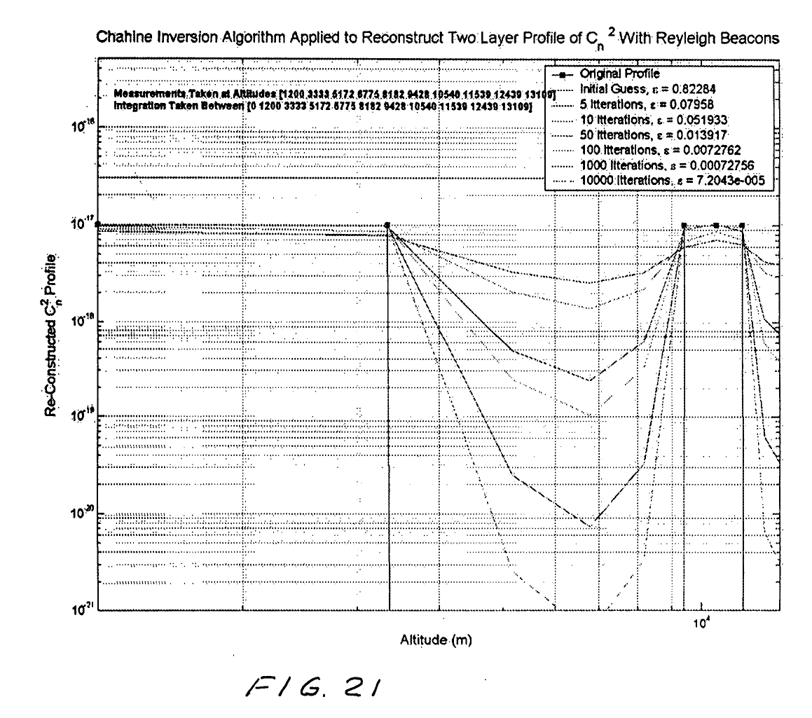

Three examples of the reconstructed turbulence profiles using Chahine inversion algorithm for the NOP field demonstration using Rayleigh beacons are shown in FIGS. 19, 20, and 21. As in the previous case with sodium LGSs, with increasing the number of iterations the reconstructed profile approaches the original profile, and the root mean square residual error is reduced. These results are encouraging. They show that reconstruction of the turbulence profile is possible.

Effects of Measurement Noise on a Reconstruction of the Turbulence Profile

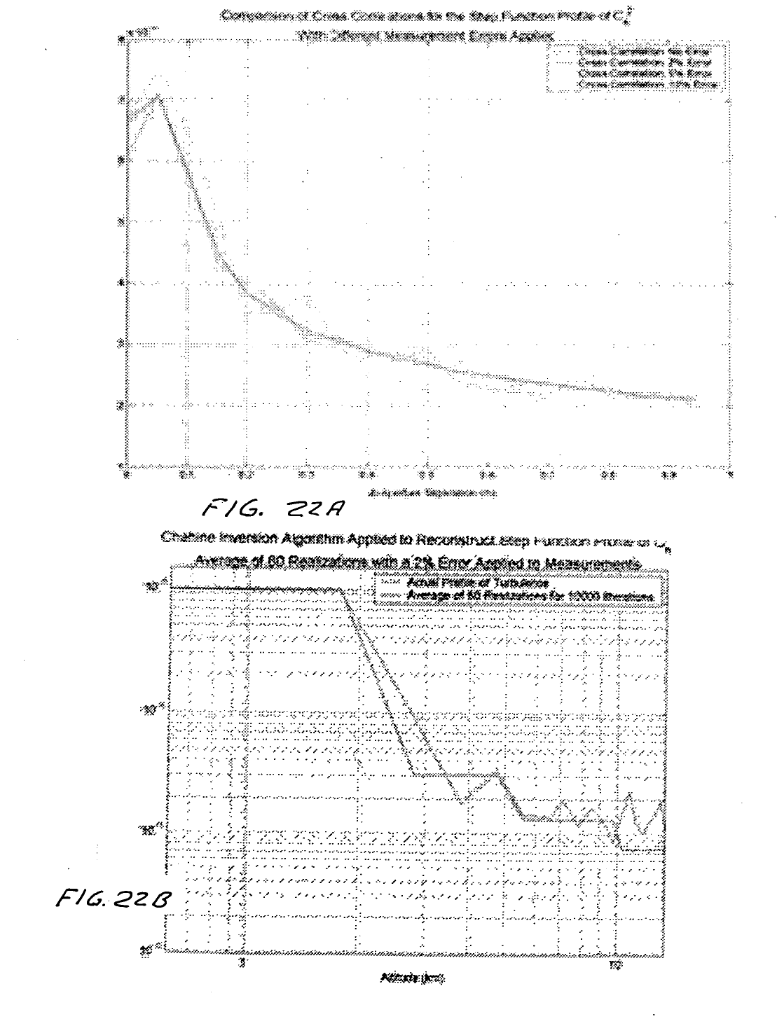

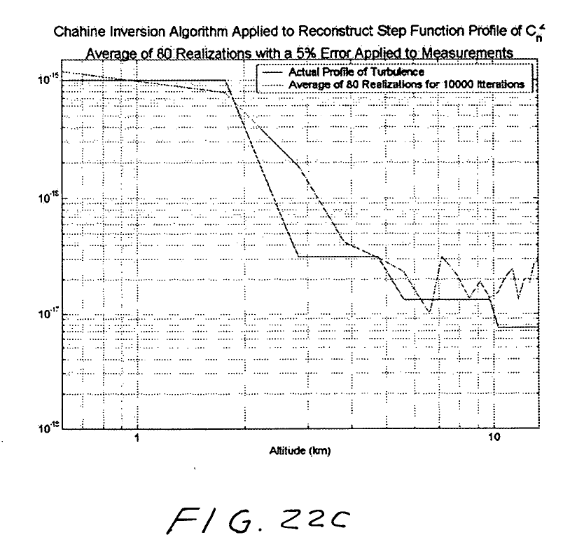

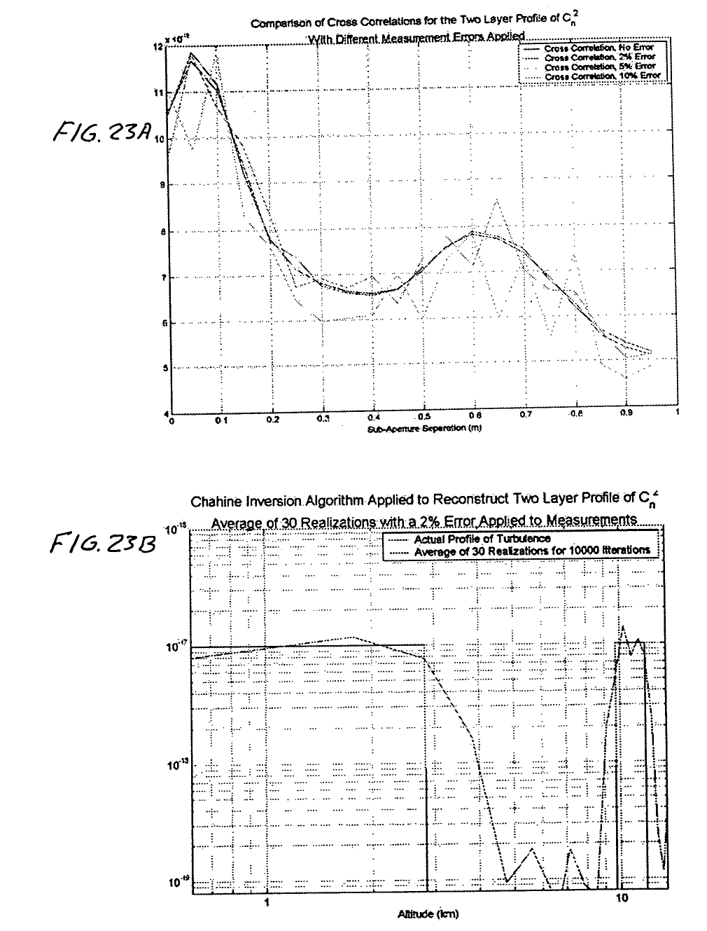

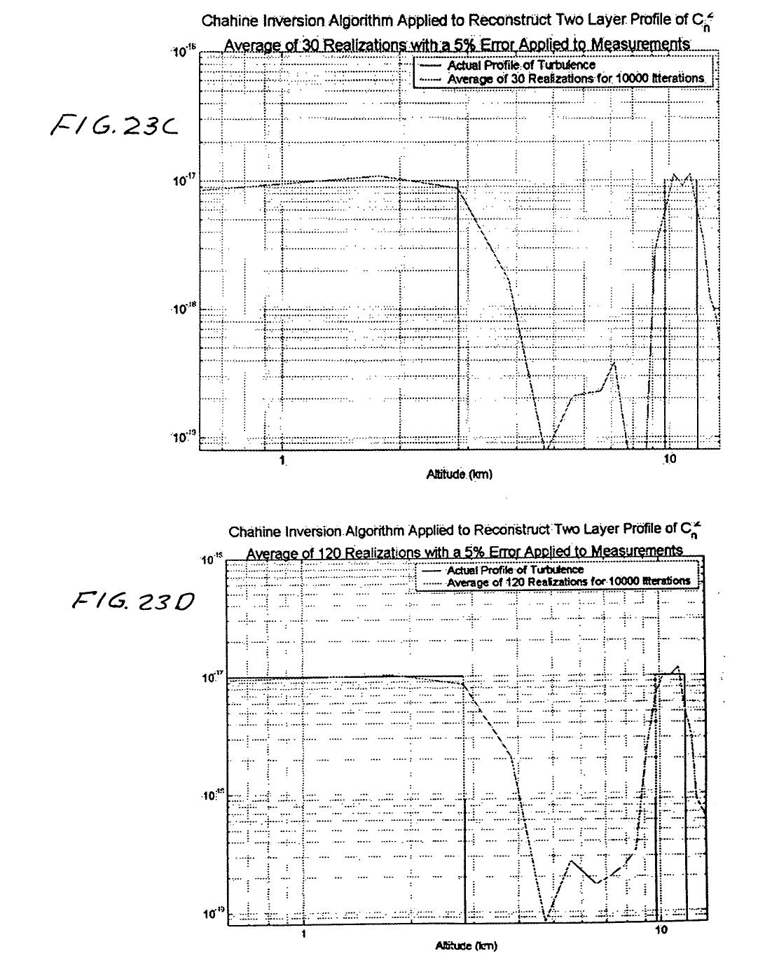

The effect of measurement noise on the reconstruction of the turbulence profile was evaluated. This was accomplished by adding zero mean Gaussian noise with rms relative error of 2%, 5%, and 10% to the calculated wavefront slope cross-correlation coefficient and then reconstructing the turbulence profile using the Chahine iterative algorithm. The results are shown in FIGS. 22 and 23. Results in FIG. 23 (c) and (d) are shown for 30 and 120 turbulence realizations. It is seen that the reconstruction algorithm is robust with respect to measurement noise. However, the algorithm overestimates the thickness of the turbulent layers.

A Modified Inversion Algorithm for Turbulence Profile Reconstruction

In order to overcome the above shortcoming, the reconstruction procedure was modified to include a rectangular fit to the reconstructed turbulence profile. The modified procedure includes two steps. First, the turbulence profile is reconstructed from the measured data using an iterative Chahine algorithm. Second, the reconstructed profile is approximated using a sum of rectangular functions

$${C}_{n}^{2} ( h ) = {\sum }_{i = 1}^{n} {a}_{i} rect ( \frac{h - {h}_{i}}{{b}_{i}} ) \qquad ( 20 )$$

where n is the number of turbulence layers, hᵢ is the layer altitude, and bᵢ is the thickness of the layer, and aᵢ is the strength of turbulence within the layer. Four parameters of the rectangular fit to the reconstructed turbulence profile are determined sequentially. First, the number of turbulence layers is determined using a threshold. Then the altitude and the thickness of the layers are determined from the Cₙ² values above the threshold. Third, the strength of turbulence is estimated from the integral values of Cₙ² for each layer. Finally, the total integral

$${μ}_{rec} = {\int }_{o}^{{H}_{max}} {C}_{n}^{2} ( h ) ⅆ h$$

estimated from the rectangular fit to the reconstructed turbulence profile is compared to the measured value of this integral

$${μ}_{0} = {\int }_{o}^{{H}_{max}} {C}_{n}^{2} ( h ) ⅆ h ,$$

which is retrieved from the variance of the slope, or differential slope, measurements for a single LGS.

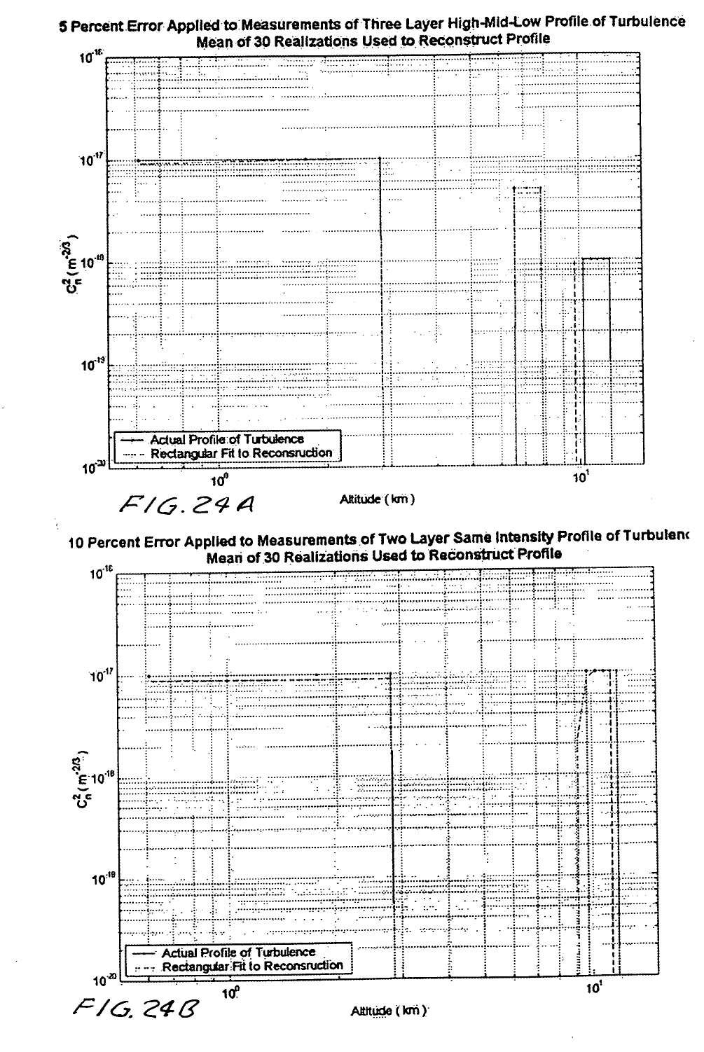

Two examples of reconstructed turbulence profiles “measured” using Rayleigh beacons at 15 km altitude are shown in FIG. 24. The reconstructed profiles are close to the original profiles. This validates the proposed approach.

### Requirements for the Cross Path LIDAR Design

Requirements for the Wavefront Sensor Dynamic Range

In order to define the requirements for dynamic range of a wavefront sensor for cross-path LIDAR, we evaluated and compared the jitter of a transmitted beam and jitter of the Rayleigh beacon image for system parameters proposed for the field demonstration at NOP.

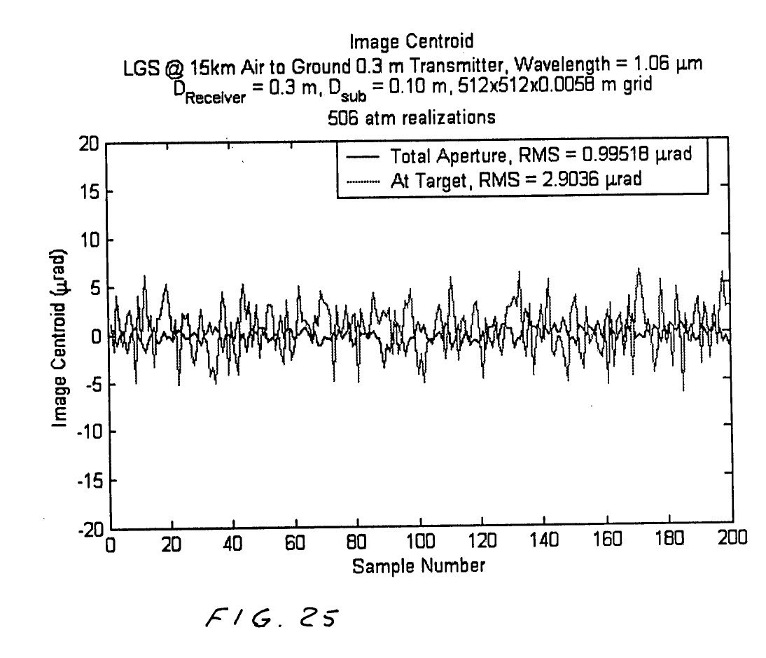

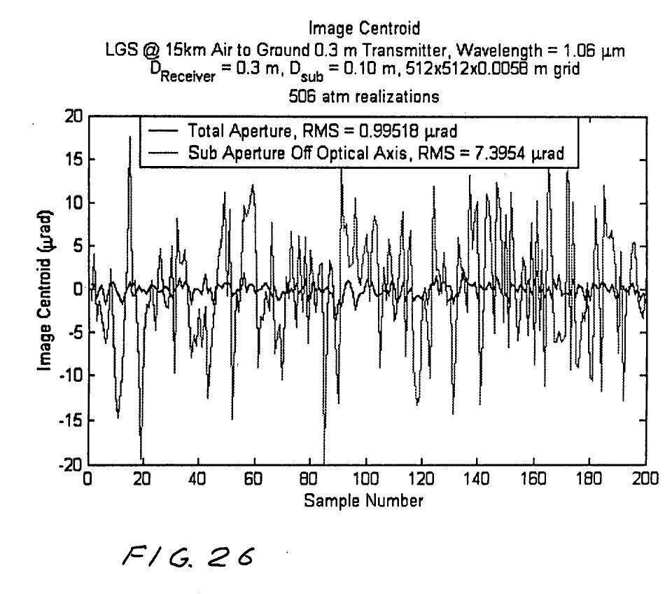

The simulation results are shown in FIGS. 25 and 26. FIG. 25 depicts the energy centroid of a transmitted beam at the Rayleigh beacon altitude, H=15 km (marked “At Target”) versus turbulence realization, or sample number, and energy centroid of the Rayleigh beacon image (marked “Total Aperture”) for a monostatic scheme when the transmitter is co-located with the receiver, and they have the same diameter, D_{T}=D_{R}=0.3 m. In this simulation, the Huffnagel-Valley HV_{5/7} turbulence model was used. It is seen that the image jitter of a Rayleigh beacon is significantly reduced, as compared to the jitter of a transmitted beam. The latter is due to beam reciprocity.

FIG. 26 compares the image jitter of a Rayleigh beacon when the transmitter is co-located with a receiver and they have the same diameter D_{T}=D_{R}=0.3 m (marked “Total Aperture”) and when the receiver having D_{R}=0.1 m diameter is separated from the transmitter having D_{T}=0.3 m diameter at distance of Δx=0.5 m (marked “Sub Aperture Off Axis”). The rms jitter of the Rayleigh beacon image exceeds the rms jitter of the transmitted beam on a one-way path by a factor of 2.6. One should take this fact into account in determining design requirements for the dynamic range of the wavefront sensor for cross-path LIDAR.

Requirements for Data Acquisition System

In the proposed field demo at NOP, a pulsed laser from Spectra Physics will be used. The pulse repetition rate of this laser is 30 Hz. Because the laser pulse repetition rate is lower than the frame rate that is commonly used in the measurements of statistical moments of a wavefront slope (≧100 Hz ), it is important to know how the system parameters including frame rate and exposure time, as well as the data acquisition time, or the number of frames in a data set, affect the accuracy of the wavefront slope statistical moments. To answer this question, we performed the following study.

By using the field data for the wavefront slope for natural stars acquired with a low-noise CCD at a 3.6 m telescope at AMOS we calculated the wavefront slope variance for a sub-aperture diameter of 0.1 m for several cases when the frame rate and data acquisition time were changed. The star imagery data was acquired with a frame rate of 100 Hz and 285 Hz. Each data set included 5,000 frames. In order to “mimic” a lower camera frame rate, we skipped every second, or every two sequential frames, in the data set. This reduced the “effective” frame rate by a factor of two, or three, respectively. Then we compared the slope variances calculated for different “effective” frame rates.

FIG. 27 depicts the time series for the azimuth and elevation wavefront slope components sampled at 100 Hz, 50 Hz, and 33 Hz effective frame rates and a 10 msec exposure time and the estimates of the wavefront slope variance. The total observation time is 50 sec. It is seen that the estimates of the wavefront slope variance are the same when the frame rate varies from 33 Hz to 100 Hz. This suggests that the laser from Spectra Physics with 30 Hz pulse repetition rate is adequate for the field demonstration of a cross-path LIDAR at NOP.

We also examined the impact of the observation time on the estimates of the wavefront slope variance. FIG. 28 shows the time series of azimuth and elevation wavefront slope components and estimates of the wavefront slope variance for different observation times. It is seen that the estimates for azimuth and elevation wavefront slope variances for the observation time of 25 sec and 50 sec differ by 12% and 5%, respectively. This suggests that an observation time on the order of 50 sec is required to obtain good accuracy for the wavefront slope statistical moments.

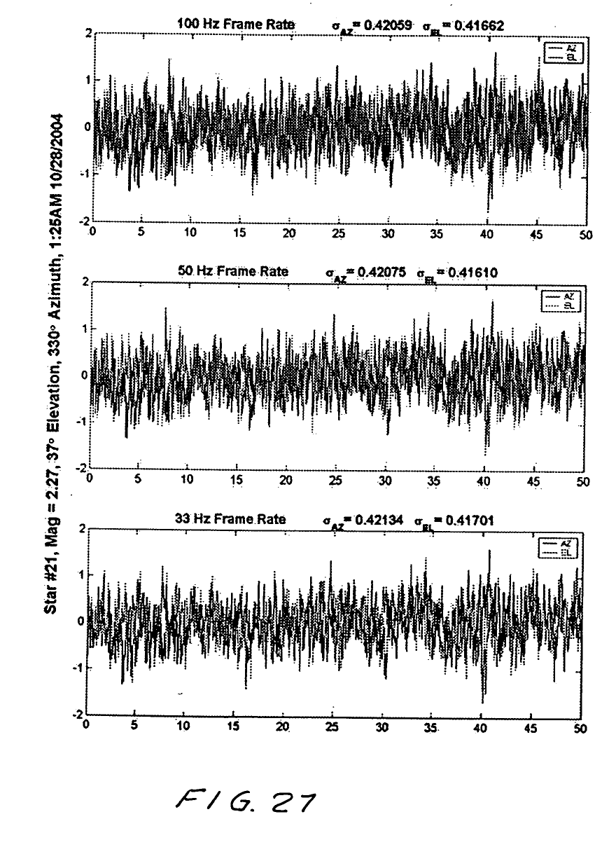

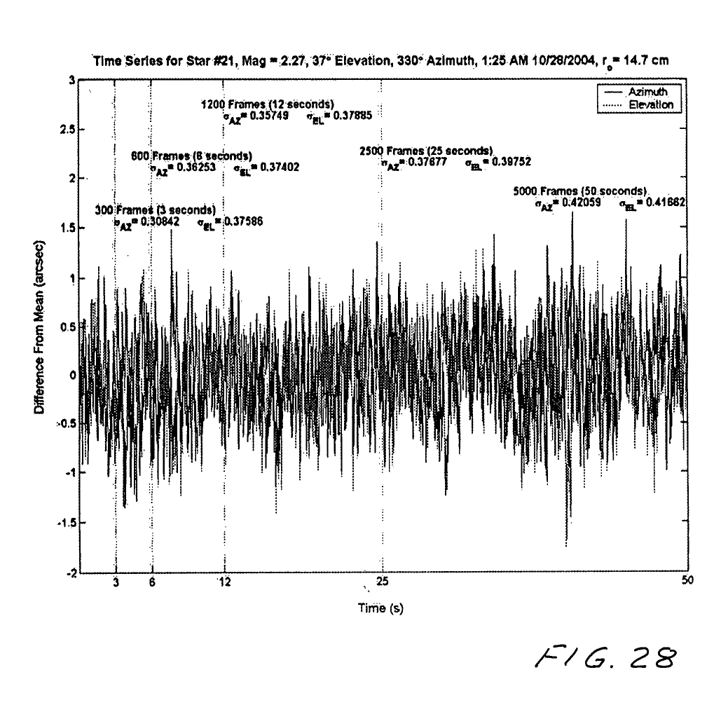

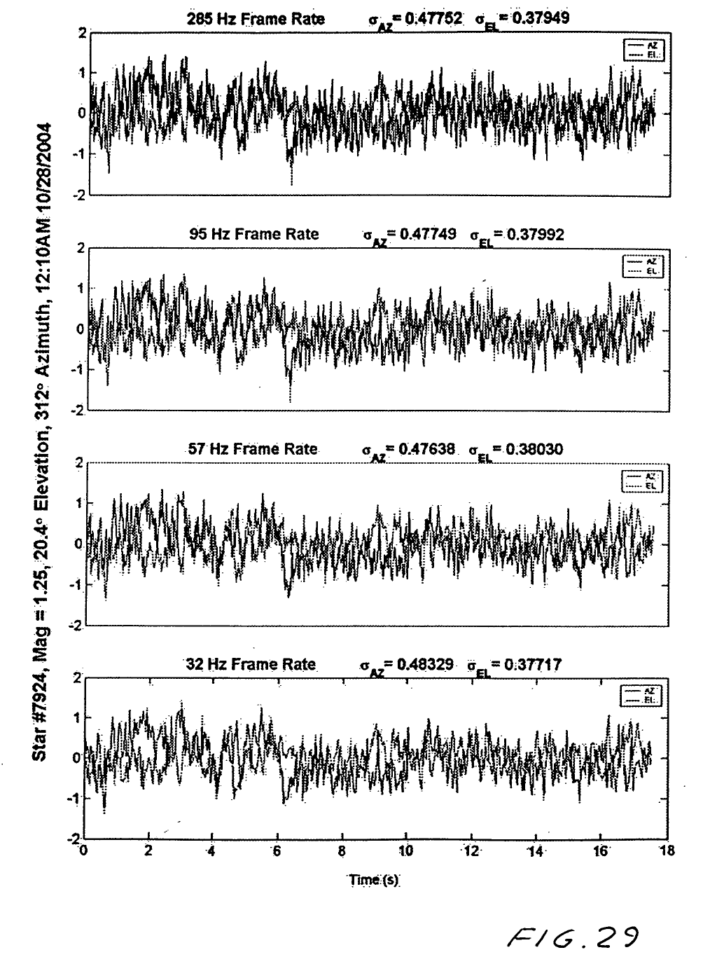

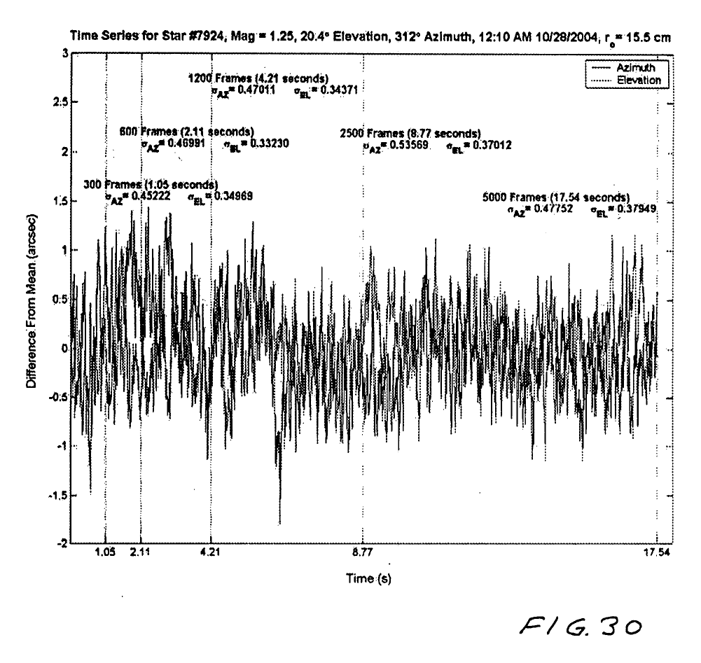

FIGS. 29 and 30 show similar results for different data set acquired with a frame rate of 285 Hz and an exposure time of 3.3 msec. An examination of these plots leads us to similar conclusions: a) the estimates of the wavefront slope variance are the same when the frame rate varies from 32 Hz to 284 Hz and b) the estimates for azimuth wavefront slope variance varies by 12% when the observation time increases from 9 sec to 17.5 sec. Note that in this case the azimuth wavefront variance exceeds the corresponding value for the elevation wavefront slop, which is an indication of the anisotropy of turbulence at AMOS.

### Design for a Wavefront Sensor and Transmitter

Transmitter Optical Bench

The laser transmitter consists of a set of beamsplitters and additional optics to generate two equal energy, but angularly separated beams, followed by a beam expanding telescope, as shown in the FIG. below. The laser beam is nominally 7 mm diameter and has a divergence of about 200 microradians, so it needs to be expanded to produce a star at the desired range less than about 10 microradians. FIG. 31 shows the laser beam coming in from below, reflecting off some prisms, and then collimated by a 200 mm to 300 mm diameter telescope. The two beams are color-coded green and red to distinguish the two optical paths. Two beams finally propagate to the left, appearing as two equal stars in the far field.

The two beams are made nearly coaxial in the near field by using polarization beam splitting cube beamsplitters and fold mirrors, as shown in FIG. 32. One laser beam enters from below, either with its polarization rotated 45 degrees with respect to the first polarizing beam splitter, or made circularly polarized with a quarter-wave plate. Fifty percent is reflected and fifty percent is transmitted through the cube. The transmitted portion, coded green, is then reflected from two mirrors back into the optical train. A small half-wave plate after the second mirror changes the polarization so that it reflects from the next cube beamsplitter. One of the simple mirrors is adjustable in tilt, so that after accounting for the beam expansion ratio, the pointing is 100 microradians from the original beam. Both cube beamsplitters are fixed.

The red-coded beam also passes through a half-wave plate fixed between the cube beamsplitters, so that this light will be transmitted instead of reflected through the next cube. An aperture stop cleans up stray reflections, and then the beam is expanded with a negative doublet lens. Because the angular split is so small, the relative divergence between the beams is not important in terms of optical aberrations. A simple parabolic mirror can be used to collimate the beam, or if space requirements are severe, a commercial Schmidt-Cassegrain telescope or other catadioptric telescope might be used.

Because this scheme generates two beams that are oppositely polarized, the receiver optics should not use polarization-sensitive optics. Alternatively, a quarter-wave plate can be used in front of the diverging lens (at the location of the aperture) to generate circularly polarized light from both beams. The two beams will still have opposite polarization, but will then be insensitive to polarizing receiver optics.

Wavefront Sensor for the Cross-Path LIDAR

The general optical layout is shown in FIG. 33. The wavefront sensor bench collimates the output of the telescope into two wavefront sensor optical paths. Light from the 1-m primary comes from the left side and comes to a focus (using auxiliary optics not shown). After a collimating and rotating optical section, the beams are allowed to diverge for one meter until they reach a second optical section that contains a translation stage and the wavefront sensor camera.

FIG. 34 shows a close-up of the collimating and rotating section. A single lens captures both stellar beams and collimates them both. For the case of natural binary stars, the angular orientation is variable, so an optical rotator is needed to realign the beams. While the two beams are at slightly different angles, the amount is relatively small and has a minimal impact on the wavefront. For the laser artificial stars, the beam can propagate directly to the next lens. For natural stars, a dove prism is used to rotate the two stellar images until they are oriented parallel to the translation stage in the next figure. The dove prism does not change the relative separation of the images, only the relative orientation; this essentially replaces the potential interference from a second translation stage. In the figure above, the dove prism is shown schematically by its outline.

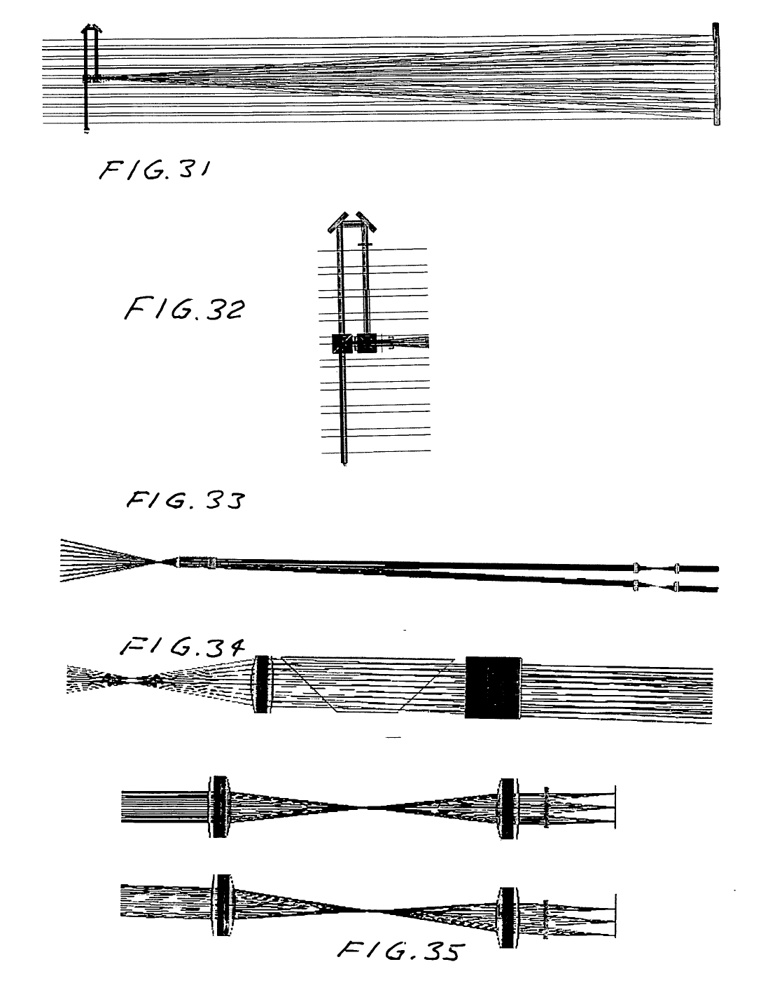

FIG. 35 shows a close-up of the lenses near the wavefront sensor focal plane. The beam is first focused and resized to meet the lenslet and focal plane spacing requirements. The lenslet array (only three lenslets are shown) focuses the two beams onto a single CCD camera. The Roper Scientific CoolSnapES camera can be perfectly synchronized with the laser pulse and electronically gated to accumulate only short exposures. Using one camera is preferred for the laser stars, since the separation is fixed. For viewing natural stars, it might be more cost effective to use two cameras that are synchronized together, then adding a fold mirror and a translation stage to separate and align the second beam. The wavefront sensor will include 10×10 sub-apertures. A CoolSnapES camera having 256×256 pixels will provide 10×10 pixels per sub-aperture.

### Determination of the Outer Scale of Turbulence and Wind Velocity

Determination of the Turbulence Outer Scale

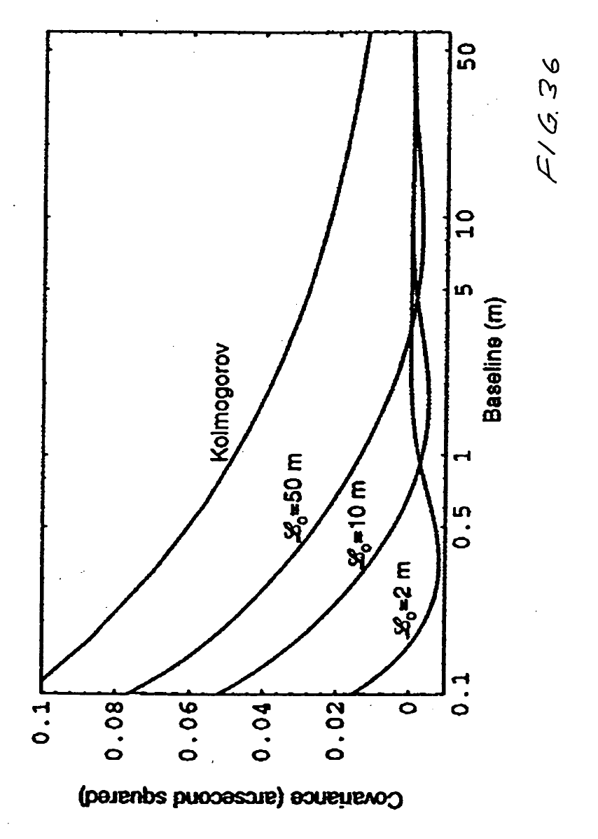

An approach for estimating the turbulence outer scale from the covariance measurements of a wavefront slope for a natural star was introduced in Ref. 21. The corresponding instrument was built, and the outer scale was monitored during 16 nights at La Silla. A similar approach can be used to measure the turbulence outer scale using a cross-path LIDAR with Rayleigh beacons. In order to illustrate this statement, FIG. 36 depicts the longitudinal covariance of a wavefront slope (wavefront slope measurements are performed in the direction parallel to the separation between the sub apertures) calculated from the analytical expression for sub-aperture diameter D=10 cm, r₀=10 cm at the wavelength of 500 nm and three values of the turbulence outer scale. It is seen that the maximum sensitivity of the covariance of a wavefront slope to the variations of the outer scale correspond to the separation between the sub-aperture (baseline) B≦1 m. This is consistent with the telescope diameter of D=1 m for the proposed field demo at NOP.

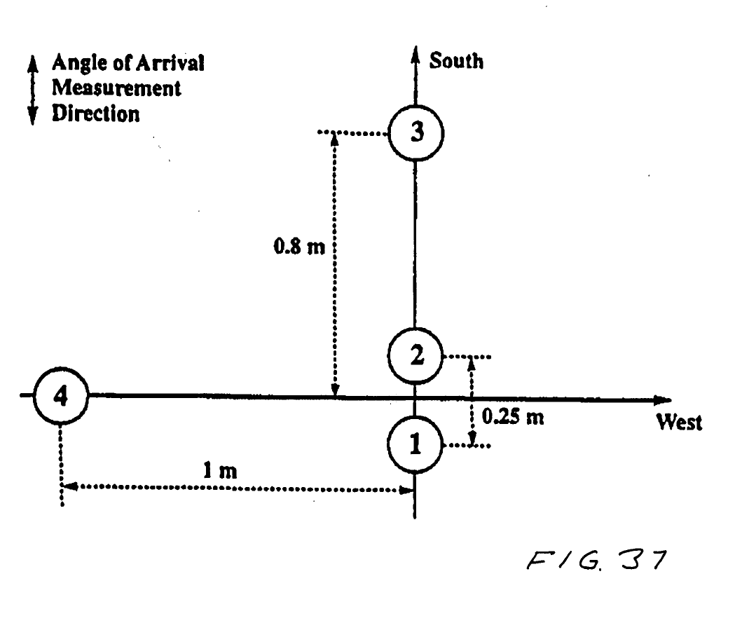

FIG. 37 depicts a geometrical layout of the Grating Scale Monitor (GSM) used in the measurements of outer scale at La Silla. The Grating Scale Monitor uses four 10-cm telescopes pointed at the same star. The maximum baseline is 1 m. This is consistent with the cross-path LIDAR parameters proposed for the field demo at NOP.

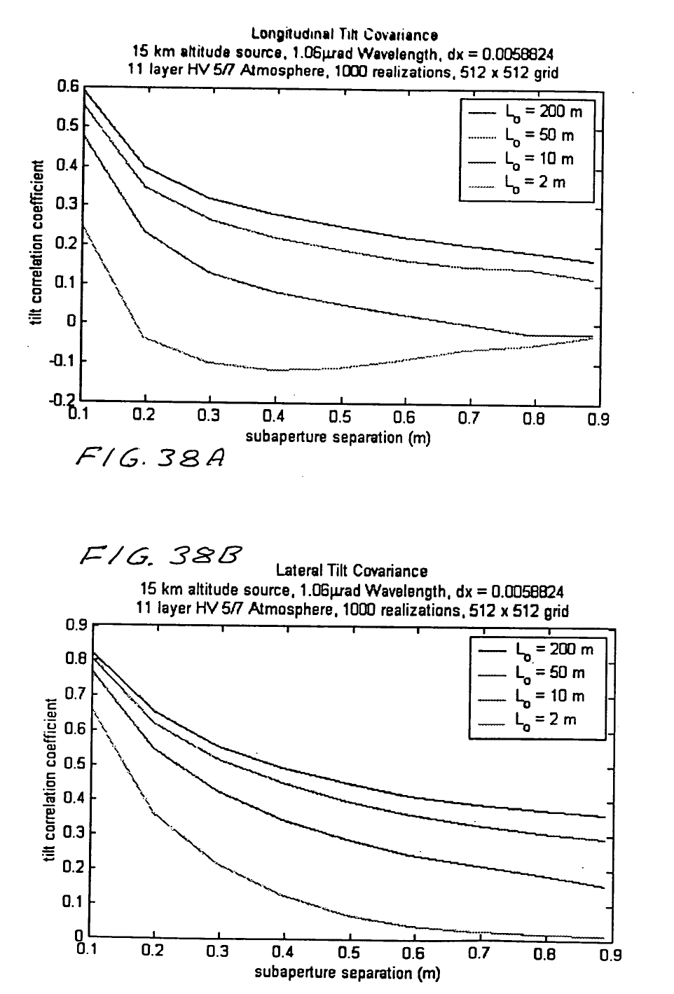

In order to calculate the calibration curves for determining the turbulence outer scale from the longitudinal and lateral covariance of the wavefront slopes using a Rayleigh beacon we employed a wave-optics simulation code. FIGS. 38A and 38B depict the longitudinal (parallel to the separation between the sub-apertures) and lateral (transverse to the separation between sub-apertures) covariance of a wavefront slope derived from the wave-optics simulation. It is seen that both longitudinal and lateral covariance of the wavefront slopes from the Rayleigh beacon are sensitive to the variations of the turbulence outer scale. This allows us to determine the outer scale using a cross-path LIDAR.

Measurement of Wind Velocity Using Rayleigh Beacons

A correlation technique for determining wind velocity from the wavefront measurements from a natural star has been demonstrated. It has been shown that a time lag of the peak of the spatial-temporal correlation of the wavefront slopes measured with a Hartmann sensor provides information about the wind speed and direction for the turbulent layer.

We validated this approach in simulation for the cross-path LIDAR configuration using a Rayleigh beacon. The system parameters used in the simulation are: the Hartmann wavefront sensor aperture diameter is D=1 m, the sub-aperture diameter is D_{sub}=10 cm, the Rayleigh beacon altitude is 15 km, wavelength is 1.06 um. The HV turbulence model and Bufton wind velocity profile were used in the simulation.

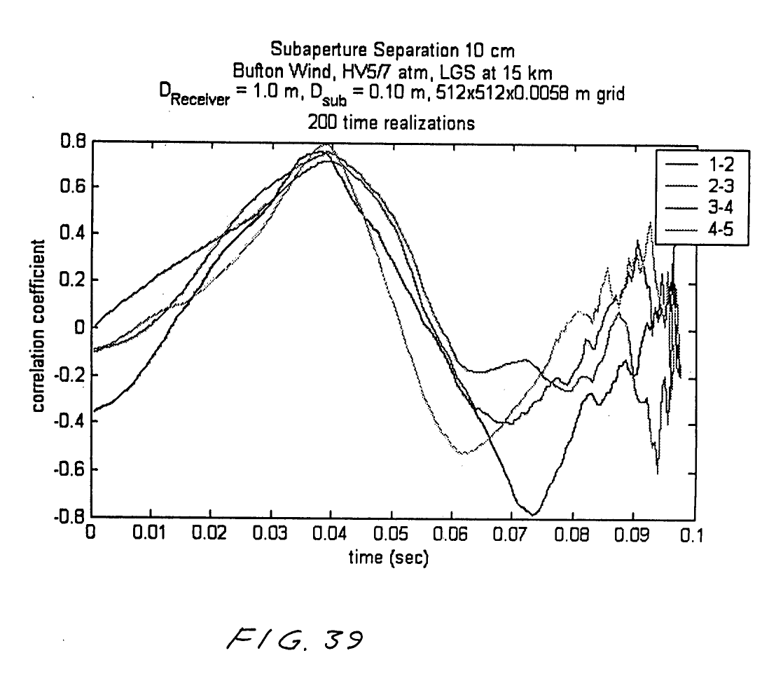

The simulation results are shown in FIG. 39. The correlation coefficient of the wavefront slopes measured with Hartmann WFS from a Rayleigh beacon was calculated for different pairs of sub-apertures separated by the distance of 0.1 m. It is seen that the time lag of the calculated correlation coefficients is 0.04 sec. Because the wind direction was selected to be parallel to the separation between the sub-apertures, the corresponding wind velocity is V=0.1 m/0.04 sec=2.5 m/sec. This estimate is consistent with the values of wind velocity in the 3 km layer near the ground for the Bufton model.

These simulation results validate the wavefront slope correlation technique for measuring wind velocity using a Rayleigh beacon. One should note that a Hartmann wavefront sensor can also operate using sodium beacons, or natural stars. Thus, a cross-path LIDAR can measure all three atmospheric characteristics that affect the imaging systems performance: turbulence profile, Cₙ²(z) turbulence outer scale, L₀, and wind velocity and wind direction.

### Advantages

Important advantages of the present invention over prior art techniques include:
Sampling of turbulent layers simultaneously at different altitudes.
High spatial and temporal resolution.
Good statistical accuracy.
Measures three atmospheric characteristics symultaneoulsy:
   1. turbulence profile,
   2. turbulence outer scale and
   3. wind velocity.
Independence of natural stars.
Can use Rayleigh beacons, sodium beacons or natural stars.

From data acquired with the present invention all parameters that characterize optical performance can be calculated including: Fried parameter, isoplanatic angle, temporal coherence scale and Greenwood frequency.

### Applications

The cross-path LIDAR has both military and commercial applications. Accurate measurements of the turbulence profile are important for active imaging, laser communication, and laser weapon systems. Commercial applications of the cross-path LIDAR include astronomical adaptive telescopes and laser communication terminals.

What is claimed is:

1. A system for measuring atmospheric turbulence comprising:
A) a pulsed laser adapted to produce two laser beams directed so as to form two artificial beacons at a desired range and separated at a desired angular distance from each other,
B) a range gated imaging camera for providing range gated image information from the artificial beacons,
C) a wavefront sensor unit for determining wavefront slopes from the image information.

2. The system as in claim 1 wherein the wavefront sensor unit comprises two Hartman sensors.

3. The system as in claim 2 wherein the wavefront sensor unit is adapted to monitor a number of layers equal to a number of sub-apertures of the wavefront sensor.

4. The system as in claim 2 wherein the wavefront sensor unit is adapted to monitor thickness of layers by a ratio of sub-aperture diameter to angular distance between laser beacons.

5. The system as in claim 1 wherein the laser is comprised of a frequency doubled laser operating at 532 nm.

6. The system as in claim 1 wherein said wavefront sensor unit comprises a computer programmed to calculate cross-correlations of wavefront slopes measured simultaneously using n_{sub}² sub-apertures.

7. The system as in claim 6 wherein said computer is also programmed to reconstruct turbulence profiles using a modified Chahine iterative inversion algorithm.

8. The system as in claim 6 wherein said computer is also programmed to determine turbulence outer scale from longitudinal and lateral wavefront slope correlation measurements.

9. The system as in claim 6 wherein said computer is also programmed to determine path-integrated wind velocity from measured spatial temporal cross-correlation of wave front slopes.

10. The system as in claim 1 wherein the beacon is a sodium beacon at altitudes of about 80 to 100 kilometers.

11. The system as in claim 1 wherein the beacon is a Raleigh beacon at altitudes of below about 16 kilometers.
